(19) United States
(12) Patent Application Publication
(10) Pub. No.: US 2015/0029165 A1
(43) Pub. Date: Jan. 29, 2015

(54) INTERACTIVE INPUT SYSTEM AND PEN TOOL THEREFOR

(71) Applicant: SMART Technologies ULC, Calgary (CA)

(72) Inventors: SEAN THOMPSON, Calgary (CA); GRANT MCGIBNEY, Calgary (CA)

(21) Appl. No.: 14/452,882

(22) Filed: Aug. 6, 2014

Related U.S. Application Data
(63) Continuation-in-part of application No. 13/838,567, filed on Mar. 15, 2013.
(60) Provisional application No. 61/618,695, filed on Mar. 31, 2012.

(51) Int. Cl. G06F 3/0354

(52) U.S. Cl. CPC G06F 3/03542; G06F 3/03545
USPC 345/179; 345/156

(57) ABSTRACT

A pen tool comprises an elongate body, a tip adjacent one end the body, and a filtered reflector disposed on the body, the filtered reflector comprising a reflecting portion and at least one filtering element, the at least one filtering element configured to permit illumination emitted at a selected wavelength to pass therethrough and impinge on the reflecting portion and to permit illumination at the selected wavelength that is reflected by the reflecting portion to exit the filtered reflector.

### CROSS-REFERENCE TO RELATED APPLICATIONS

This application is a continuation-in-part of U.S. patent application Ser. No. 13/838,567 filed on Mar. 15, 2013, which claims the benefit of U.S. Provisional Application No. 61/618,695 filed on Mar. 31, 2012, the entire contents of which are incorporated herein by reference.

### FIELD

The subject application relates to an interactive input system and to a pen tool therefor.

### BACKGROUND

Interactive input systems that allow users to inject input into an application program using an active pointer (e.g. a pointer that emits light, sound or other signal), a passive pointer (e.g. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001 assigned to SMART Technologies ULC of Calgary, Alberta, Canada, assignee of the subject application, the entire disclosures of which are incorporated by reference; touch systems comprising touch panels employing electromagnetic, capacitive, acoustic or other technologies to register pointer input; tablet and laptop personal computers (PCs); smartphones, personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Pat. No. 6,972,401 to Akitt et al. assigned to SMART Technologies ULC, the entire disclosure of which is incorporated herein by reference, discloses an illuminated bezel for use in a touch system such as that disclosed in above-incorporated U.S. Pat. No. 6,803,906 to Morrison et al. The illuminated bezel comprises infrared (IR) light emitting diodes (LEDs) that project infrared light onto diffusers. The diffusers in turn, diffuse the infrared light so that the intensity of backlighting provided over the touch surface by the illuminated bezel is generally even across the surfaces of the diffusers. As a result, the backlight illumination provided by the bezel appears generally continuous to the digital cameras. Although this illuminated bezel works very well, it adds cost to the touch system.

U.S. Patent Application Publication No. 2011/0242060 to McGibney et al., filed on Apr. 1, 2010, and assigned to SMART Technologies ULC, the entire disclosure of which is incorporated herein by reference, discloses an interactive input system comprising at least one imaging assembly having a field of view looking into a region of interest and capturing image frames and processing structure in communication with the at least one imaging assembly. When a pointer exists in captured image frames, the processing structure demodulates the captured image frames to determine frequency components thereof and examines the frequency components to determine at least one attribute of the pointer.

U.S. Patent Application Publication No. 2011/0242006 to Thompson et al., filed on Apr. 1, 2010, and assigned to SMART Technologies ULC, the entire disclosure of which is incorporated herein by reference, discloses a pen tool for use with a machine vision interactive input system comprising an elongate body and a tip arrangement at one end of the body, an end surface of the body at least partially about the tip arrangement carrying light reflective material that is visible to at least one imaging assembly of the interactive input system when the pen tool is angled.

U.S. Pat. Nos. 7,202,860 and 7,414,617 to Ogawa disclose a coordinate input device that includes a pair of cameras positioned in an upper left position and an upper right position of a display screen of a monitor lying close to a plane extending from the display screen of the monitor and views both a side face of an object in contact with a position on the display screen and a predetermined desktop coordinate detection area to capture the image of the object within the field of view. The coordinate input device also includes a control circuit which calculates the coordinate value of a pointing tool, pointing to a position within a coordinate detection field, based on video signals output from the pair of cameras, and transfers the coordinate value to a program of a computer.

U.S. Pat. No. 6,567,078 to Ogawa discloses a handwriting communication system, a handwriting input device and a handwriting display device used in the system, which can communicate by handwriting among a plurality of computers connected via a network. The communication system includes a handwriting input device which is provided at a transmitting side for inputting the handwriting into a transmitting side computer, and a handwriting display device which is provided at a receiving side for displaying the handwriting based on information transmitted from the transmitting side to a receiving side computer. The system transmits only a contiguous image around the handwritten portion, which reduces the communication volume compared to transmitting the whole image, and which makes the real time transmission and reception of handwriting trace possible.

U.S. Pat. No. 6,441,362 to Ogawa discloses an optical digitizer for determining a position of a pointing object projecting a light and being disposed on a coordinate plane. In the optical digitizer, a detector is disposed on a periphery of the coordinate plane and has a view field covering the coordinate plane for receiving the light projected from the pointing object and for converting the received light into an electric signal. A processor is provided for processing the electric signal fed from the detector to compute coordinates representing the position of the pointing object. A collimator is disposed to limit the view field of the detector below a predetermined height relative to the coordinate plane such that through the limited view field the detector can receive only a parallel component of the light which is projected from the pointing object substantially in parallel to the coordinate plane. A shield is disposed to enclose the periphery of the coordinate plane to block a noise light other than the projected light from entering into the limited view field of the detector.

Although the above references disclose a variety of interactive input systems, improvements are generally desired. It is therefore an object at least to provide a novel interactive input system and a novel pen tool therefor.

### SUMMARY

Accordingly, in one aspect there is provided a pen tool comprising an elongate body, a tip adjacent one end the body, and a filtered reflector disposed on the body, the filtered reflector comprising a reflecting portion and at least one filtering element, the at least one filtering element configured to permit illumination emitted at a selected wavelength to pass therethrough and impinge on the reflecting portion and to permit illumination at the selected wavelength that is reflected by the reflecting portion to exit the filtered reflector.

In one embodiment, the filtered reflector is positioned adjacent the tip. The selected wavelength is within the infrared (IR) spectrum. The at least one filtering element is an optical bandpass filter having a peak wavelength corresponding to the selected wavelength. The peak wavelength is one of 780 nm, 830 nm, and 880 nm.

According to another aspect there is provided an interactive input system comprising at least one imaging assembly having a field of view aimed into a region of interest and capturing image frames thereof, at least one light source configured to emit illumination into the region of interest at a selected wavelength, and processing structure configured to process the captured image frames to determine a location of at least one pointer in a first region of the captured image frames, to define a pointer analysis region in the captured image frames separate from the first region, and to identify the at least one pointer based on a calculated intensity of at least a portion of the pointer analysis region.

According to another aspect there is provided a method of identifying at least one pointer brought into proximity with an interactive input system, the method comprising emitting illumination into a region of interest from at least one light source at a selected wavelength, capturing image frames of the region of interest, and processing the captured image frames to determine a location of at least one pointer in a first region of the captured image frames, to define a pointer analysis region in the captured image frames separate from the first region, and to identify the at least one pointer based on a calculated intensity of at least a portion of the pointer analysis region.

According to another aspect there is provided a non-transitory computer readable medium tangibly embodying a computer program for execution by a computer to perform a method for identifying at least one pointer brought into proximity with an interactive input system, the method comprising emitting illumination into a region of interest from at least one light source at a selected wavelength, capturing image frames of the region of interest, and processing the captured image frames to determine a location of at least one pointer in a first region of the captured image frames, to define a pointer analysis region in the captured image frames separate from the first region, and to identify the at least one pointer based on a calculated intensity of at least a portion of the pointer analysis region.

### BRIEF DESCRIPTION OF THE DRAWINGS

Embodiments will now be described more fully with reference to the accompanying drawings in which:

FIG. 1 is a schematic perspective view of an interactive input system;

FIG. 2 is a schematic block diagram view of the interactive input system of FIG. 1;

FIG. 3 is a block diagram of an imaging assembly forming part of the interactive input system of FIG. 1;

FIG. 4 is a front perspective view of a housing assembly forming part of the imaging assembly of FIG. 3;

FIG. 5 is a block diagram of a master controller forming part of the interactive input system of FIG. 1;

FIG. 6a is a perspective view of a pen tool for use with the interactive input system of FIG. 1;

FIG. 6b is a side cross-sectional view of a portion of the pen tool of FIG. 6a;

FIG. 7a is a perspective view of another pen tool for use with the interactive input system of FIG. 1;

FIG. 7b is a side cross-sectional view of a portion of the pen tool of FIG. 7a;

FIG. 8 shows an image frame capture sequence used by the interactive input system of FIG. 1;

FIG. 9 is a flowchart showing steps of an image processing method;

FIGS. 10A and 10B are exemplary captured image frames;

FIG. 11 shows another embodiment of an image frame capture sequence used by the interactive input system of FIG. 1;

FIG. 12 is a side cross-sectional view of a portion of another embodiment of a pen tool for use with the interactive input system of FIG. 1;

FIG. 13 is a perspective view of another embodiment of an interactive input system;

FIG. 14 is a schematic plan view of an imaging assembly arrangement employed by the interactive input system of FIG. 13;

FIG. 15 shows an image frame capture sequence used by the interactive input system of FIG. 13;

FIG. 16 is a schematic side elevational view of another embodiment of an interactive input system;

FIG. 17 is a schematic side elevational view of yet another embodiment of an interactive input system;

FIG. 18 is a schematic top plan view of yet another embodiment of an interactive input system;

FIG. 19a is a perspective view of a pen tool for use with the interactive input system of FIG. 18;

FIG. 19b is a side cross-sectional view of a portion of the pen tool of FIG. 19a;

FIG. 19c is a side cross-sectional view of another portion of the pen tool of FIG. 19a;

FIG. 20a is a perspective view of another pen tool for use with the interactive input system of FIG. 18;

FIG. 20b is a side cross-sectional view of a portion of the pen tool of FIG. 20a;

FIG. 20c is a side cross-sectional view of another portion of the pen tool of FIG. 20a;

FIG. 21 is a flowchart showing steps of an image processing method;

FIG. 22 is a schematic view showing four operational phases of an illuminated bezel of the interactive input system of FIG. 18; and

FIG. 23 shows an image frame capture sequence used by the interactive input system of FIG. 18.

### DETAILED DESCRIPTION OF THE EMBODIMENTS

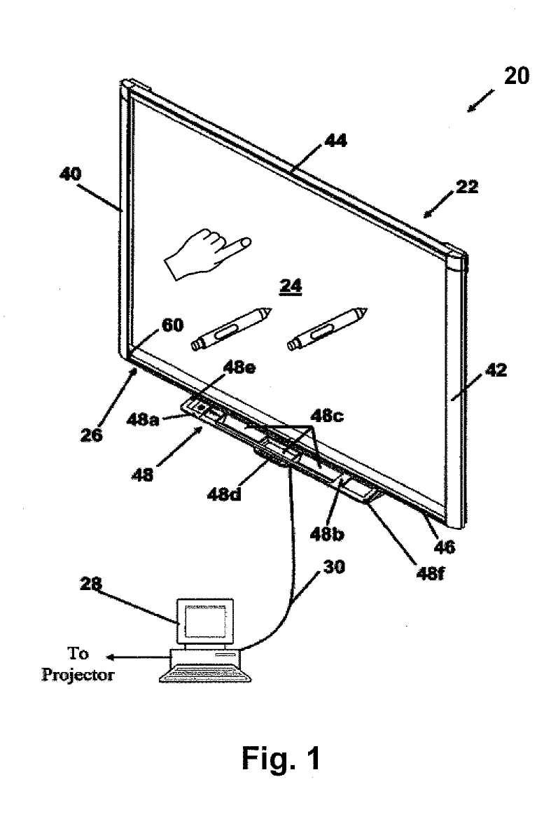

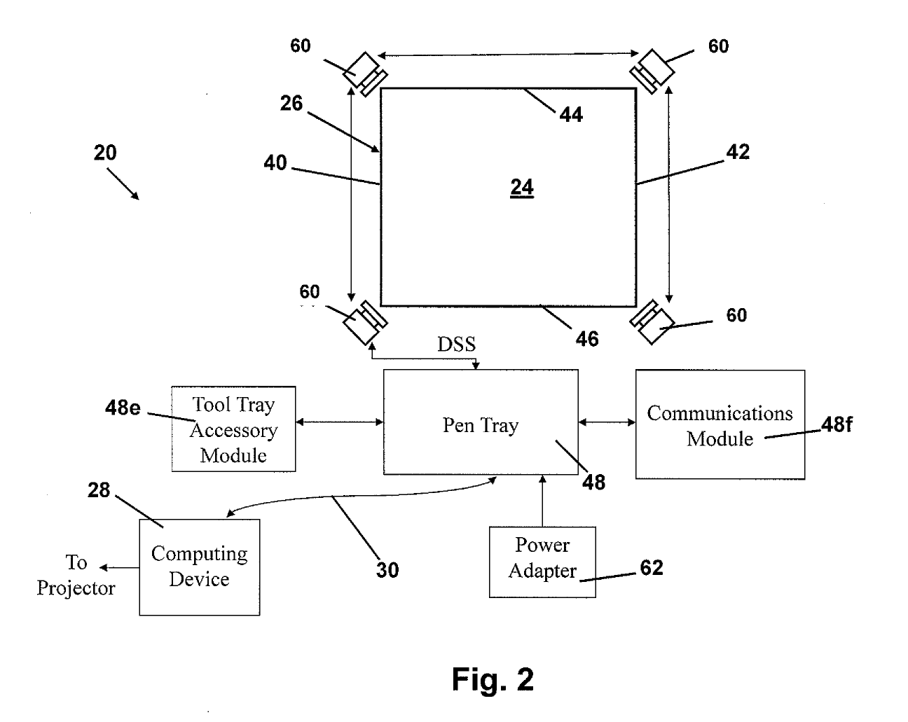

Turning now to FIGS. 1 and 2, an interactive input system that allows a user to inject input such as digital ink, mouse events etc. into an application program is shown and is generally identified by reference numeral 20. In this embodiment, interactive input system 20 comprises an interactive board 22 mounted on a vertical support surface such as for example, a wall surface or the like or otherwise supported or suspended in an upright orientation. Interactive board 22 comprises a generally planar, rectangular interactive surface 24 that is surrounded about its periphery by a bezel 26. An ultra-short throw projector (not shown) such as that sold by SMART Technologies ULC under the name SMART UX60 is also mounted on the support surface above the interactive board 22 and projects an image, such as for example a computer desktop, onto the interactive surface 24.

The interactive board 22 employs machine vision to detect one or more pointers brought into a region of interest in proximity with the interactive surface 24. The interactive board 22 communicates with a general purpose computing device 28 executing one or more application programs via a universal serial bus (USB) cable 30 or other suitable wired or wireless connection. General purpose computing device 28 processes the output of the interactive board 22 and, if required, adjusts image data output to the projector so that the image presented on the interactive surface 24 reflects pointer activity. In this manner, the interactive board 22, general purpose computing device 28 and projector allow pointer activity proximate to the interactive surface 24 to be recorded as writing or drawing or used to control execution of one or more application programs executed by the general purpose computing device 28.

The bezel 26 in this embodiment is mechanically fastened to the interactive surface 24 and comprises four bezel segments 40, 42, 44, 46. Bezel segments 40 and 42 extend along opposite side edges of the interactive surface 24 while bezel segments 44 and 46 extend along the top and bottom edges of the interactive surface 24 respectively. In this embodiment, the inwardly facing surface of each bezel segment 40, 42, 44 and 46 comprises a single, longitudinally extending strip or band of retro-reflective material. To take best advantage of the properties of the retro-reflective material, the bezel segments 40, 42, 44 and 46 are oriented so that their inwardly facing surfaces extend in a plane generally normal to the plane of the interactive surface 24.

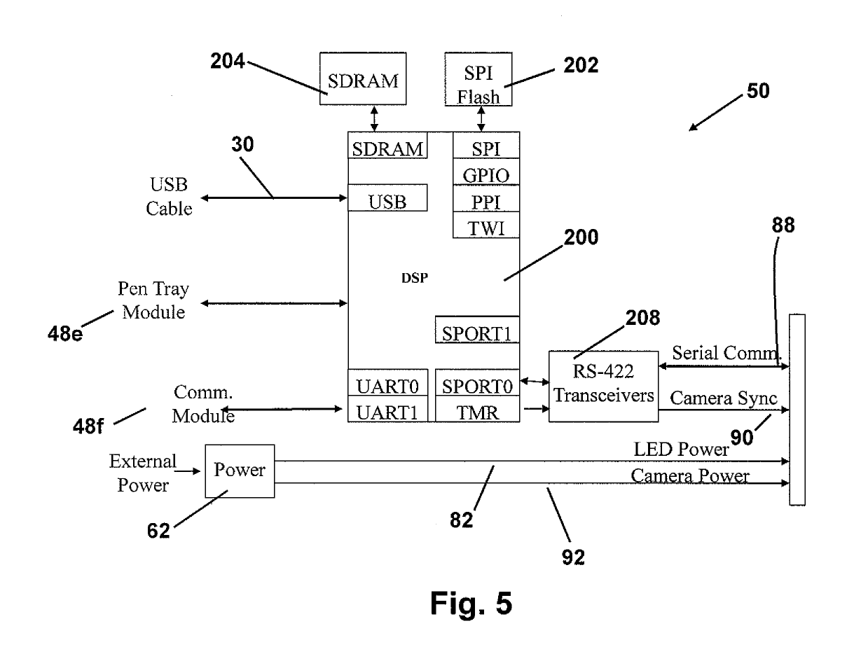

A tool tray 48 is affixed to the interactive board 22 adjacent the bezel segment 46 using suitable fasteners such as for example, screws, clips, adhesive etc. As can be seen, the tool tray 48 comprises a housing 48a having an upper surface 48b configured to define a plurality of receptacles or slots 48c. The receptacles 48c are sized to receive one or more pen tools as will be described as well as an eraser tool that can be used to interact with the interactive surface 24. Control buttons 48d are provided on the upper surface 48b of the housing 48a to enable a user to control operation of the interactive input system 20. One end of the tool tray 48 is configured to receive a detachable tool tray accessory module 48e while the opposite end of the tool tray 48 is configured to receive a detachable communications module 48f for remote device communications. The housing 48a accommodates a master controller 50 (see FIG. 5) as will be described. The tool tray 48 is described further in U.S. Patent Application Publication No. 2011/0169736 to Bolt et al., filed on Feb. 19, 2010, and assigned to SMART Technologies ULC, the relevant portions of the disclosure of which are incorporated herein by reference.

As shown in FIG. 2, imaging assemblies 60 are accommodated by the bezel 26, with each imaging assembly 60 being positioned adjacent a different corner of the bezel. The imaging assemblies 60 are oriented so that their fields of view overlap and look generally across the entire interactive surface 24. In this manner, any pointer such as for example a user's finger, a cylinder or other suitable object, or a pen tool or eraser tool lifted from a receptacle 48c of the tool tray 48, that is brought into proximity of the interactive surface 24 appears in the fields of view of the imaging assemblies 60. A power adapter 62 provides the necessary operating power to the interactive board 22 when connected to a conventional AC mains power supply.

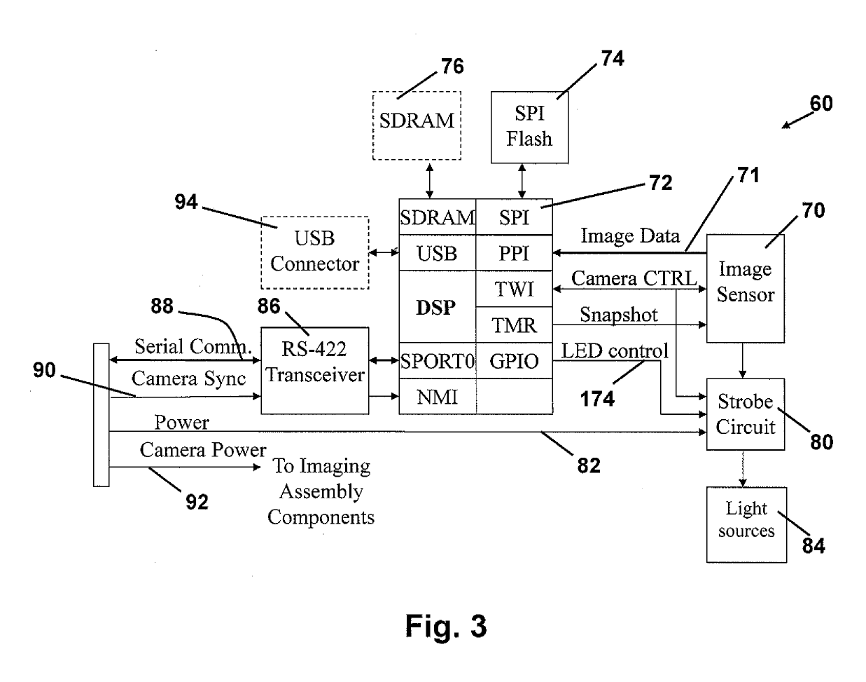

Turning now to FIG. 3, components of one of the imaging assemblies 60 are shown. As can be seen, the imaging assembly 60 comprises a grey scale image sensor 70 such as that manufactured by Aptina (Micron) under Model No. MT9V034 having a resolution of 752×480 pixels, fitted with a two element, plastic lens (not shown) that provides the image sensor 70 with a field of view of approximately 104 degrees. In this manner, the other imaging assemblies 60 are within the field of view of the image sensor 70 thereby to ensure that the field of view of the image sensor 70 encompasses the entire interactive surface 24.

A digital signal processor (DSP) 72 such as that manufactured by Analog Devices under part number ADSP-BF522 Blackfin or other suitable processing device, communicates with the image sensor 70 over an image data bus 71 via a parallel port interface (PPI). A serial peripheral interface (SPI) flash memory 74 is connected to the DSP 72 via an SPI port and stores the firmware required for imaging assembly operation. Depending on the size of captured image frames as well as the processing requirements of the DSP 72, the imaging assembly 60 may optionally comprise synchronous dynamic random access memory (SDRAM) 76 to store additional temporary data as shown by the dotted lines. The image sensor 70 also communicates with the DSP 72 via a two-wire interface (TWI) and a timer (TMR) interface. The control registers of the image sensor 70 are written from the DSP 72 via the TWI in order to configure parameters of the image sensor 70 such as the integration period for the image sensor 70.

In this embodiment, the image sensor 70 operates in snapshot mode. In the snapshot mode, the image sensor 70, in response to an external trigger signal received from the DSP 72 via the TMR interface that has a duration set by a timer on the DSP 72, enters an integration period during which an image frame is captured. Following the integration period after the generation of the trigger signal by the DSP 72 has ended, the image sensor 70 enters a readout period during which time the captured image frame is available. With the image sensor in the readout period, the DSP 72 reads the image frame data acquired by the image sensor 70 over the image data bus 71 via the PPI. The frame rate of the image sensor 70 in this embodiment is between about 900 and about 960 frames per second. The DSP 72 in turn processes image frames received from the image sensor 70 and provides pointer information to the master controller 50 at a reduced rate of approximately 100 points/sec. Those of skill in the art will however appreciate that other frame rates may be employed depending on the desired accuracy of pointer tracking and whether multi-touch and/or active pointer identification is employed.

Two strobe circuits 80 communicate with the DSP 72 via the TWI and via a general purpose input/output (GPIO) interface. The strobe circuits 80 also communicate with the image sensor 70 and receive power provided on LED power line 82 via the power adapter 62. Each strobe circuit 80 drives a respective illumination source in the form of an infrared (IR) light emitting diode (LED) 84a and 84b that provides infrared backlighting over the interactive surface 24. Further specifics concerning the strobe circuits 80 and their operation are described in U.S. Patent Application Publication No. 2011/0169727 to Akitt, filed on Feb. 19, 2010, and assigned to SMART Technologies ULC, the relevant portions of the disclosure of which are incorporated herein by reference.

The DSP 72 also communicates with an RS-422 transceiver 86 via a serial port (SPORT0) and a non-maskable interrupt (NMI) port. The transceiver 86 communicates with the master controller 50 over a differential synchronous signal (DSS) communications link 88 and a synch line 90. Power for the components of the imaging assembly 60 is provided on power line 92 by the power adapter 62. DSP 72 may also optionally be connected to a USB connector 94 via a USB port as indicated by the dotted lines. The USB connector 94 can be used to connect the imaging assembly 60 to diagnostic equipment.

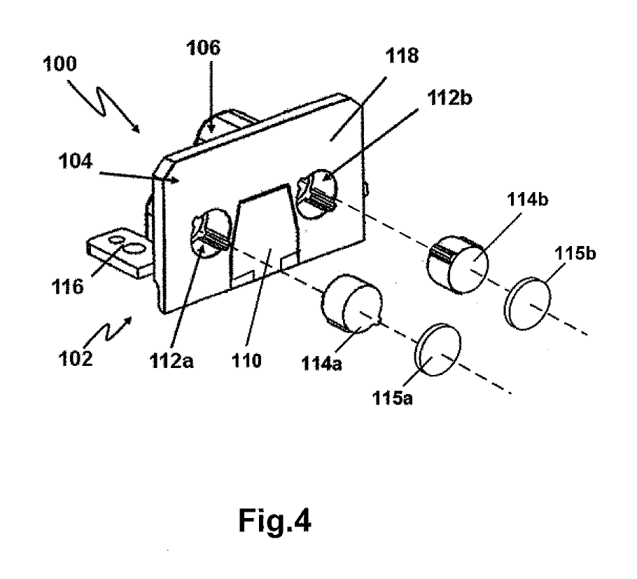

The image sensor 70 and its associated lens as well as the IR LEDs 84a and 84b are mounted on a housing assembly 100 that is shown in FIG. 4. As can be seen, the housing assembly 100 comprises a polycarbonate housing body 102 having a front portion 104 and a rear portion 106 extending from the front portion. An imaging aperture 108 is centrally formed in the housing body 102 and accommodates an IR-pass/visible light blocking filter 110. In this embodiment, the filter 110 has a wavelength range between about 810 nm and about 900 nm. The image sensor 70 and associated lens are positioned behind the filter 110 and oriented such that the field of view of the image sensor 70 looks through the filter 110 and generally across the interactive surface 24. The rear portion 106 is shaped to surround the image sensor 70. Two passages 112a and 112b are formed through the housing body 102. Passages 112a and 112b are positioned on opposite sides of the filter 110 and are in general horizontal alignment with the image sensor 70.

Tubular passage 112a receives a light source socket 114a that is configured to receive IR LED 84a. In this embodiment, IR LED 84a emits IR light having a peak wavelength of about 830 nm and is of the type such as that manufactured by Vishay under Model No. TSHG8400. Tubular passage 112a also receives an IR-bandpass filter 115a. The filter 115a has an IR-bandpass wavelength range of about 830 nm±12 nm and is the type such as that manufactured by HB Optical Filters under Model No. NIR Narrow Bandpass Filter, 830 nm+/−12 nm. The light source socket 114a and associated IR LED 84a are positioned behind the IR-bandpass filter 115a and oriented such that IR illumination emitted by IR LED 84a passes through the IR-bandpass filter 115a and generally across the interactive surface 24.

Tubular passage 112b receives a light source socket 114b that is configured to receive IR LED 84b. In this embodiment, IR LED 84b emits IR light having a peak wavelength of about 875 nm and is of the type such as that manufactured by Vishay under Model No. TSHA5203. Tubular passage 112b also receives an IR-bandpass filter 115b. The filter 115b has an IR-bandpass wavelength range of about 880 nm±12 nm and is of the type such as that manufactured by HB Optical Filters under Model No. NIR Narrow Bandpass Filter, 880 nm+/−12 nm. The light source socket 114b and associated IR LED 84b are positioned behind the IR-bandpass filter 115b and oriented such that IR illumination emitted by IR LED 84b passes through the IR-bandpass filter 115b and generally across the interactive surface 24.

Mounting flanges 116 are provided on opposite sides of the rear portion 106 to facilitate connection of the housing assembly 100 to the bezel 26 via suitable fasteners. A label 118 formed of retro-reflective material overlies the front surface of the front portion 104. Further specifics concerning the housing assembly and its method of manufacture are described in U.S. Patent Application Publication No. 2011/0170253 to Liu et al., filed on Feb. 19, 2010, and assigned to SMART Technologies ULC, the relevant portions of the disclosure of which are incorporated herein by reference.

Components of the master controller 50 are shown in FIG. 5. As can be seen, master controller 50 comprises a DSP 200 such as that manufactured by Analog Devices under part number ADSP-BF522 Blackfin or other suitable processing device. A serial peripheral interface (SPI) flash memory 202 is connected to the DSP 200 via an SPI port and stores the firmware required for master controller operation. A synchronous dynamic random access memory (SDRAM) 204 that stores temporary data necessary for system operation is connected to the DSP 200 via an SDRAM port. The DSP 200 communicates with the general purpose computing device 28 over the USB cable 30 via a USB port. The DSP 200 communicates through its serial port (SPORT0) with the imaging assemblies 60 via an RS-422 transceiver 208 over the differential synchronous signal (DSS) communications link 88. In this embodiment, as more than one imaging assembly 60 communicates with the master controller DSP 200 over the DSS communications link 88, time division multiplexed (TDM) communications is employed. The DSP 200 also communicates with the imaging assemblies 60 via the RS-422 transceiver 208 over the camera synch line 90. DSP 200 communicates with the tool tray accessory module 48e over an inter-integrated circuit (I²C) channel and communicates with the communications module 48f over universal asynchronous receiver/transmitter (UART), serial peripheral interface (SPI) and I²C channels.

As will be appreciated, the architectures of the imaging assemblies 60 and master controller 50 are similar. By providing a similar architecture between each imaging assembly 60 and the master controller 50, the same circuit board assembly and common components may be used for both thus reducing the part count and cost of the interactive input system 20. Differing components are added to the circuit board assemblies during manufacture dependent upon whether the circuit board assembly is intended for use in an imaging assembly 60 or in the master controller 50. For example, the master controller 50 may require a SDRAM 76 whereas the imaging assembly 60 may not.

The general purpose computing device 28 in this embodiment is a personal computer or other suitable processing device comprising, for example, a processing unit comprising one or more processors, system memory (volatile and/or non-volatile memory), other non-removable or removable memory (e.g. a hard disk drive, RAM, ROM, EEPROM, CD-ROM, DVD, flash memory, etc.) and a system bus coupling the various computer components to the processing unit. The general purpose computing device 28 may also comprise a network connection to access shared or remote drives, one or more networked computers, or other networked devices.

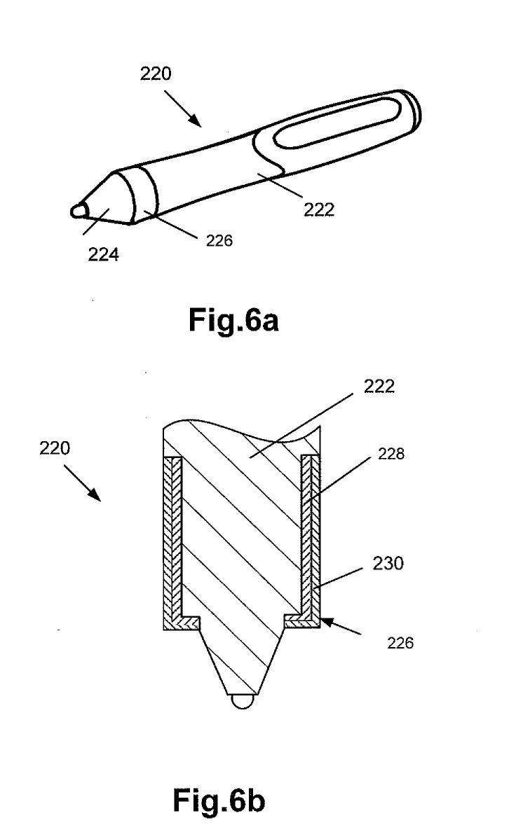

FIGS. 6a and 6b show a pen tool 220 for use with the interactive input system 20. As can be seen, pen tool 220 has a main body 222 terminating in a generally conical tip 224. A filtered reflector 226 is provided on the body 222 adjacent the tip 224. Filtered reflector 226 comprises a reflective element 228 and a filtering element 230. The reflective element 228 encircles a portion of the body 222 and is formed of a retro-reflective material such as for example retro-reflective tape. The filtering element 230 is positioned atop and circumscribes the reflective element 228. The filtering element 230 is formed of the same material as the IR-bandpass filter 115a such that the filtering element 230 has an IR-bandpass wavelength range of about 830 nm±12 nm.

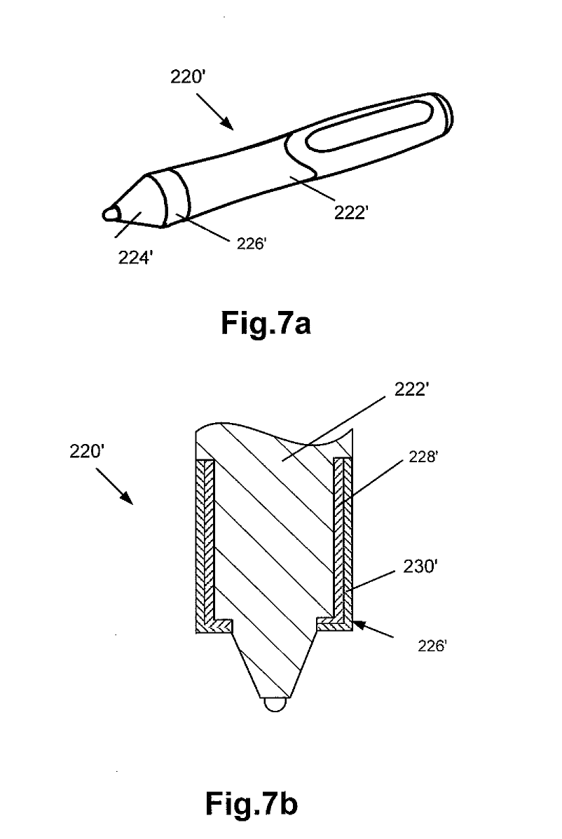

FIGS. 7a and 7b show another pen tool 220′ for use with the interactive input system 20 that is similar to pen tool 220. As can be seen, pen tool 220′ has a main body 222′ terminating in a generally conical tip 224′. A filtered reflector 226′ is provided on the body 222′ adjacent the tip 224′. Filtered reflector 226′ comprises a reflective element 228′ and a filtering element 230′. The reflective element 228′ encircles a portion of the body 222′ and is formed of a retro-reflective material such as for example retro-reflective tape. The filtering element 230′ is positioned atop and circumscribes the reflective element 228′. The filtering element 230′ is formed of the same material as the IR-bandpass filter 115b such that the filtering element 230′ has an IR-bandpass wavelength range of about 880 nm±12 nm.

The differing filtering elements 230 and 230′ of the pen tools 220 and 220′ enable the interactive input system 20 to differentiate between the pen tools 220 and 220′ when the pen tools are brought into proximity with the interactive surface 24, as will be described below.

During operation, the DSP 200 of the master controller 50 outputs synchronization signals that are applied to the synch line 90 via the transceiver 208. Each synchronization signal applied to the synch line 90 is received by the DSP 72 of each imaging assembly 60 via transceiver 86 and triggers a non-maskable interrupt (NMI) on the DSP 72. In response to the non-maskable interrupt triggered by the synchronization signal, the DSP 72 of each imaging assembly 60 ensures that its local timers are within system tolerances and if not, corrects its local timers to match the master controller 50. Using one local timer, the DSP 72 initiates a pulse sequence via the snapshot line that is used to condition the image sensor 70 to the snapshot mode and to control the integration period and frame rate of the image sensor 70 in the snapshot mode. The DSP 72 also initiates a second local timer that is used to provide output on the LED control line 174 so that the IR LEDs 84a and 84b are properly powered during the image frame capture cycle. In this embodiment, the pulse sequences and the outputs on the LED control line 174 are generated so that the image frame capture rate of each image sensor 70 is nine (9) times the desired image frame output rate.

In response to the pulse sequence output on the snapshot line, the image sensor 70 of each imaging assembly 60 acquires image frames at the desired image frame rate. In this manner, image frames captured by the image sensor 70 of each imaging assembly can be referenced to the same point of time allowing the position of pointers brought into the fields of view of the image sensors 70 to be accurately triangulated. Each imaging assembly 60 has its own local oscillator (not shown) and synchronization signals are distributed so that a lower frequency synchronization signal for each imaging assembly 60 is used to keep image frame capture synchronized. By distributing the synchronization signals for the imaging assemblies 60, rather than, transmitting a fast clock signal to each imaging assembly 60 from a central location, electromagnetic interference is reduced.

During image frame capture by each imaging assembly 60, one of IR LEDs 84a and 84b of the imaging assembly 60 is ON. As a result, the region of interest over the interactive surface 24 is flooded with infrared illumination. The infrared illumination has a peak wavelength of about 830 nm when IR LED 84a is ON and about 875 nm when IR LED 84b is ON Infrared illumination that impinges on the retro-reflective bands of bezel segments 40, 42, 44 and 46 and on the retro-reflective labels 118 of the housing assemblies 100 is returned to the imaging assembly 60. Additionally, reflections of the illuminated retro-reflective bands of bezel segments 40, 42, 44 and 46 and the illuminated retro-reflective labels 118 appearing on the interactive surface 24 are visible to the image sensor 70. As a result, in the absence of a pointer, the image sensor 70 of the imaging assembly 60 sees a bright band having a substantially even intensity over its length, together with any ambient light artifacts. When a pointer is brought into proximity with the interactive surface 24, the pointer occludes infrared illumination. As a result, the image sensor 70 of the imaging assembly 60 sees a dark region that interrupts the bright band.

If pen tool 220 is brought into proximity with the interactive surface 24 during image frame capture and the filtering element 230 has the same passband as the IR-bandpass filter associated with the IR LED that is ON, the image sensor 70 of the imaging assembly 60 will also see a bright region having a high intensity above the bright band corresponding to infrared illumination that impinges on the filtered reflector 226 of the pen tool 220 as a result of the infrared illumination being able to pass through the filtering element 230 and being reflected by the reflective element 228. The intensity of the bright region will be greater than an intensity threshold. A reflection of the bright region appearing on the interactive surface 24 is also visible to the image sensor 70, below the bright band. If filtering element 230 of the pen tool 220 does not have the same passband as the IR-bandpass filter associated with the IR LED that is ON, the image frame captured by the image sensor 70 of the imaging assembly 60 will not comprise a bright region having an intensity greater than the intensity threshold as a result of the infrared illumination not being able to pass through the filtering element 230. By comparing the intensity of the bright region to the intensity threshold and by monitoring which IR LED is ON, the identity of the pen tool 220 can be determined.

If pen tool 220′ is brought into proximity with the interactive surface 24 during image frame capture and the filtering element 230′ has the same passband as the IR-bandpass filter associated with the IR LED that is ON, the image sensor 70 of the imaging assembly 60 will also see a bright region having a high intensity above the bright band corresponding to infrared illumination that impinges on the filtered reflector 226′ of the pen tool 220′ as a result of the infrared illumination being able to pass through the filtering element 230′ and being reflected by the reflective element 228′. The intensity of the bright region will be greater than an intensity threshold. A reflection of the bright region appearing on the interactive surface 24 is also visible to the image sensor 70, below the bright band. If filtering element 230′ of the pen tool 220′ does not have the same passband as the IR-bandpass filter associated with the IR LED that is ON, the image frame captured by the image sensor 70 of the imaging assembly 60 will not comprise a bright region having an intensity greater than the intensity threshold as a result of the infrared illumination not being able to pass through the filtering element 230′. By comparing the intensity of the bright region to the intensity threshold and by monitoring which IR LED is ON, the identity of the pen tool 220 can be determined.

When the IR light sources 82a and 82b are OFF, no infrared illumination impinges on the retro-reflective bands of bezel segments 40, 42, 44 and 46 or on the retro-reflective labels 118 of the housing assemblies 100. Consequently, the image sensor 70 of the imaging assembly 60 will not see the retro-reflective bands or the retro-reflective labels 118. During this situation, if either pen tool 220 or pen tool 220′ is brought into proximity with the interactive surface 24, no infrared illumination impinges on its filtered reflector and consequently the image sensor 70 of the imaging assembly 60 will not see a bright region corresponding to the filtered reflector. The imaging assembly 60 will however see artifacts resulting from ambient light on a dark background. The ambient light typically comprises light originating from the operating environment surrounding the interactive input system 20, and infrared illumination emitted by the IR LEDs that is scattered off of objects proximate to the imaging assemblies 60.

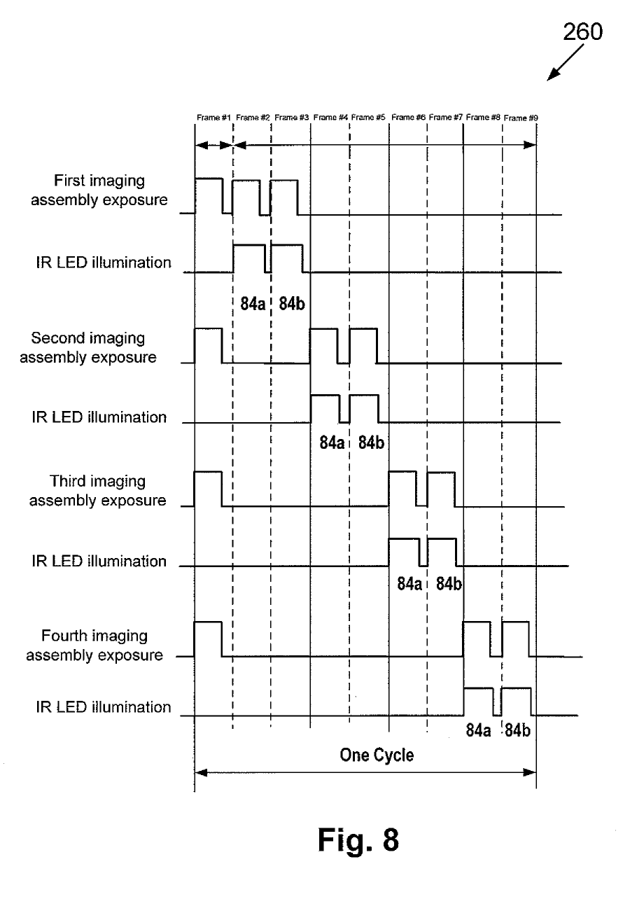

FIG. 8 shows a portion of an image frame capture sequence 260 used by the interactive input system 20. A background image frame (“Frame #1”) is initially captured by each of the imaging assemblies 60 with the IR LEDs 84a and 84b OFF. A first one of the imaging assemblies 60 is conditioned to capture an image frame (“Frame #2”) with its IR LED 84a ON and its IR LED 84b OFF and then to capture another image frame (“Frame #3”) with its IR LED 84b OFF and its IR LED 84b ON. The remaining three imaging assemblies 60 and their associated IR LEDs 84a and 84b are inactive when Frame #2 and Frame #3 are being captured. A second one of the imaging assemblies 60 is then conditioned to capture an image frame (“Frame #4”) with its IR LED 84a ON and its IR LED 84b OFF and then to capture another image frame (“Frame #5”) with its IR LED 84b OFF and its IR LED 84b ON. The remaining three imaging assemblies 60 and their associated IR LEDs 84a and 84b are inactive when Frame #4 and Frame #5 are being captured. A third one of the imaging assemblies 60 is then conditioned to capture an image frame (“Frame #6”) with its IR LED 84a ON and its IR LED 84b OFF and then to capture another image frame (“Frame #7”) with its IR LED 84b OFF and its IR LED 84b ON. The remaining three imaging assemblies 60 and their associated IR LEDs 84a and 84b are inactive when Frame #6 and Frame #7 are being captured. A fourth one of the imaging assemblies 60 is then conditioned to capture an image frame (“Frame #8”) with its IR LED 84a ON and its IR LED 84b OFF and then to capture another image frame (“Frame #9”) with IR LED 84b OFF and IR LED 84b ON. The remaining three imaging assemblies 60 and their associated IR LEDs 84a and 84b are inactive when Frame #8 and Frame #9 are being captured. As a result, the exposure of the image sensors 70 of the four (4) imaging assemblies 60 and the powering of the associated IR LEDs 84a and 84b are staggered to avoid any effects resulting from illumination of neighbouring IR LEDs.

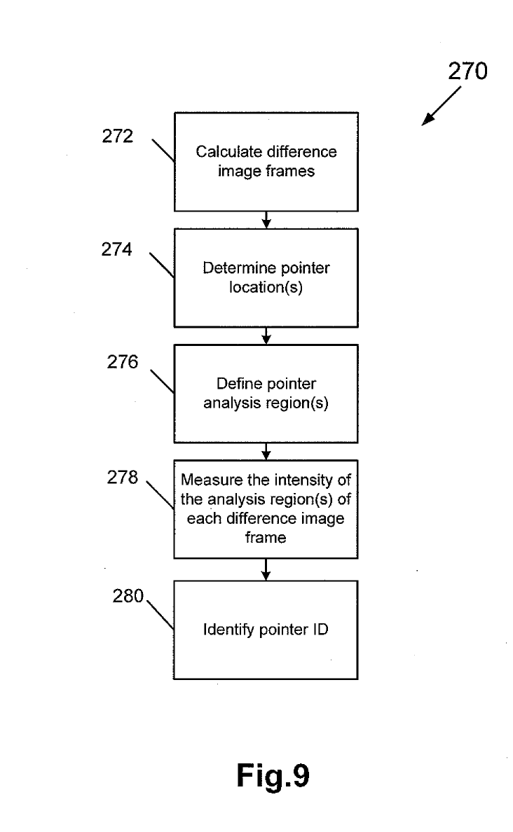

Once the sequence of image frames has been captured, the image frames in the sequence are processed according to an image frame processing method, which is shown in FIG. 9 and is generally indicated by reference numeral 270. To reduce the effects of ambient light, difference image frames are calculated. Each difference image frame is calculated by subtracting the background image frame (“Frame 1”) captured by a particular imaging assembly 60 from the other image frames captured by that particular imaging assembly 60. In particular, the background image frame (“Frame 1”) captured by the first imaging assembly 60 is subtracted from the two image frames (“Frame 2” and “Frame 3”), the background image frame (“Frame 1”) captured by the second imaging assembly 60 is subtracted from the image frames (“Frame 4” and “Frame 5”), the background image frame (“Frame 1”) captured by the third imaging assembly 60 is subtracted from the two image frames (“Frame 6” and “Frame 7”) and the background image frame (“Frame 1”) captured by the fourth imaging assembly 60 is subtracted from the two image frames (“Frame 8” and “Frame 9”). As a result, eight difference image frames (“Difference Image Frame #2” to “Difference Image Frame #9”) are generated having ambient light removed (step 272).

The difference image frames are then examined for values that represent the bezel and possibly one or more pointers (step 274). Methods for determining pointer location within image frames are described in U.S. Patent Application Publication No. 2009/0277697 to Bolt et al., filed on May 9, 2008, and assigned to SMART Technologies ULC, the relevant portions of the disclosure of which are incorporated herein by reference. As mentioned above, when a pointer exists in a captured image frame, the pointer occludes illumination and appears as a dark region interrupting the bright band. Thus, the bright bands in the difference image frames are analyzed to determine the locations of dark regions.

Once the locations of dark regions representing one or more pointers in the difference image frames have been determined, one or more square-shaped pointer analysis regions are defined directly above the bright band and dark regions (step 276). In the event that pen tool 220 or pen tool 220′ appears in the captured image frames and the filtering element of the pen tool 220 or pen tool 220′ has the same passband as the IR-bandpass filter associated with the IR LED that is ON, the one or more square-shaped pointer analysis regions will comprise a bright region corresponding to infrared illumination that impinges on the filtered reflector of the pen tool 220 or pen tool 220′ and is reflected by the reflective element thereof. The intensity of the bright region is then calculated and compared to an intensity threshold (step 278).

For a particular difference image frame, if the intensity of the bright region that is within the pointer analysis region is above the intensity threshold, the dark region is determined to be caused by one of the pen tools 220 and 220′ and the pen tool can be identified (step 280). For example, if the intensity of the bright region that is within the pointer analysis region is above the intensity threshold in Difference Image Frame #2, pen tool 220 is identified, as it is known that Difference Image Frame #2 is calculated using Frame #2, which is captured when IR LED 84a is ON. Difference Frame #3 is calculated using Frame #3 (captured when IR LED 84b is ON). As such pen tool 220 is not identifiable in Difference Image Frame #3 since the illumination emitted by IR LED 84b is filtered out by the filtering element 230 of pen tool 220.

Once the identity of the pen tool 220 or pen tool 220′ is determined, the identity may be used to assign an attribute such as for example a pen color (red, green, black, blue, yellow, etc.) or a pen function (mouse, eraser, passive pointer) to the pen tool 220 or pen tool 220′. In the event the pen tool 220 or pen tool 220′ is assigned the pen function of a mouse, the pen tool 220 or pen tool 220′ may be further assigned a sub-attribute such as for example a right mouse click, a left mouse click, a single mouse click, or a double mouse click. The pen tool 220 or pen tool 220′ may alternatively be associated with a particular user.

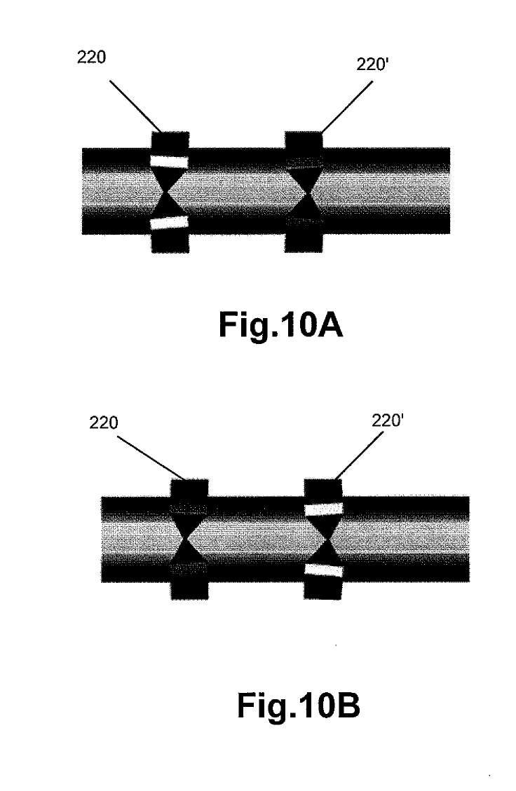

Turning now to FIGS. 10A and 10B, exemplary difference image frames are shown. The difference image frames are associated with image frames captured in the event pen tool 220 and pen tool 220′ are in proximity with the interactive surface 24 with IR LED 84a ON and IR LED 84b OFF (FIG. 10A) and IR LED 84a OFF and IR LED 84b ON (FIG. 10B). As can be seen, the difference image frames comprise a direct image of pen tool 220 and pen tool 220′ as well as a reflected image of pen tool 220 and pen tool 220′appearing on the interactive surface 24. Only the direct image of each pen tool 220 and 220′ is used for processing.

As can be seen in FIG. 10A, the filtered reflector 226 of pen tool 220 is illuminated as the illumination emitted by IR LED 84a passes through the filtering element 230 and is reflected by the reflective element 228 back through the filtering element 230 and towards the imaging assembly 60. The filtered reflector 226′ of pen tool 220′ is not illuminated as the illumination emitted by IR LED 84a is blocked by the filtering element 230′.

As can be seen in FIG. 10B, the filtered reflector 226 of pen tool 220 is not illuminated as the illumination emitted by IR LED 84b is blocked by the filtering element 230. The filtered reflector 226′ of pen tool 220′ is illuminated as the illumination emitted by IR LED 84b passes through the filtering element 230′ and is reflected by the reflective element 228′ back through the filtering element 230′ and towards the imaging assembly 60.

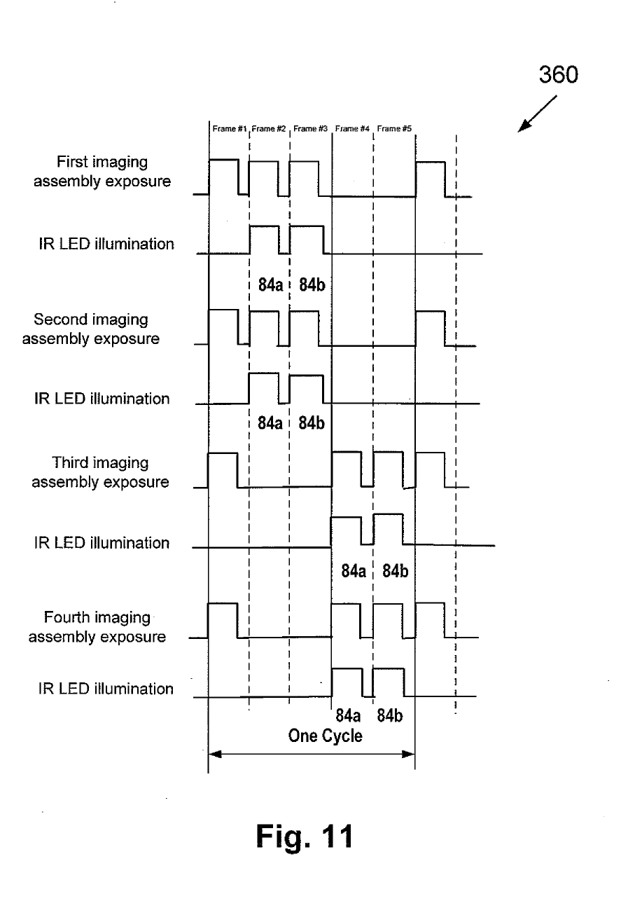

As will be appreciated, the image frame capture sequence is not limited to that described above. In other embodiments, different image frame capture sequences may be used. For example, in another embodiment, first and second ones of the imaging assemblies 60 are configured to capture image frames generally simultaneously while third and fourth ones of the imaging assemblies 60 are inactive, and vice versa. An exemplary image frame capture sequence for this embodiment is shown in FIG. 11 and is generally indicated using reference numeral 360. A background image frame (“Frame #1”) is initially captured by each of the imaging assemblies 60 with all IR LEDs 84a and 84b OFF. First and second ones of the imaging assemblies 60 are then conditioned to capture an image frame (“Frame 2”) with their IR LEDs 84a ON and their IR LEDs 84b OFF and then to capture another image frame (“Frame 3”) with their IR LEDs 84a OFF and their IR LEDs 84b ON. The other two imaging assemblies and their associated IR LEDs 84a and 84b are inactive when Frame #2 and Frame #3 are being captured. Third and fourth ones of the imaging assemblies 60 are then conditioned to capture an image frame (“Frame 4”) with their IR LEDs 84a ON and their IR LEDs 84b OFF and then to capture another image frame (“Frame 5”) with their IR LEDs 84a OFF and their IR LEDs 84b ON. The other two imaging assemblies and their associated IR LEDs 84a and 84b are inactive when Frame #4 and Frame #5 are being captured. As a result, the exposure of the image sensors 70 of the first and second imaging assemblies 60 and the powering of the associated IR LEDs 84a and 84b are opposite those of the third and fourth imaging assemblies 60 to avoid any potential effects resulting from illumination of opposing IR LEDs and to reduce the time of the image frame capture sequence, thereby increasing the overall system processing speed. In this embodiment, the master controller 50 operates at a rate of 160 points/second and the image sensors operate at a frame rate of 960 frames per second.

Once the sequence of image frames has been captured, the image frames are processed according to an image frame processing method similar to image frame processing method 270 described above.

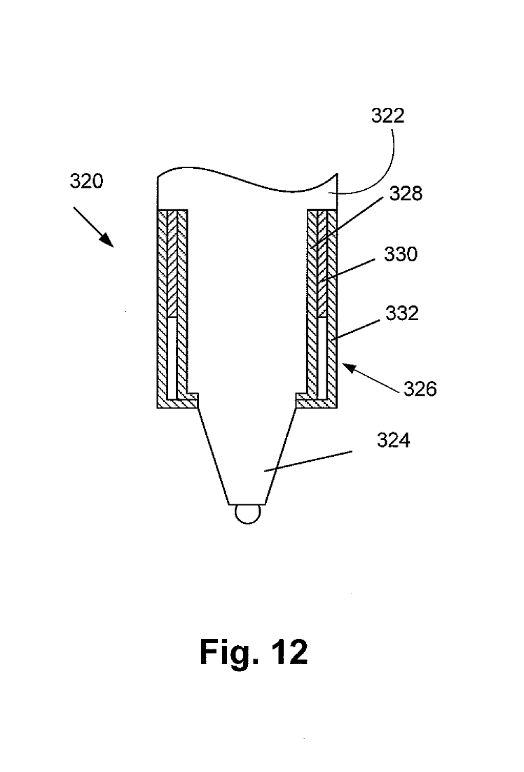

FIG. 12 shows another embodiment of a pen tool generally indicated using reference numeral 320. Pen tool 320 is similar to pen tool 220 described above, and comprises a filtered reflector 326 adjacent the generally conical tip 324 of the pen tool body 322. Similar to pen tool 220, the filtered reflector 326 comprises a reflective element 328 and a filtering element 330. The reflective element 328 encircles a portion of the body and is made of a retro-reflective material such as for example retro-reflective tape. The filtering element 330 is positioned atop and circumscribes an upper portion of the reflective element 328. In this embodiment, the lower portion of the reflective element 328 is not covered by the filtering element 330. A transparent protective layer 332 is positioned atop and circumscribes the filtering element 330 and the reflective element 328.

Since the lower portion of the reflective element 328 is not covered by the filtering element 330, IR illumination emitted by any of the IR LEDs is reflected by the lower portion of the reflective element 328, enabling the pen tool 320 to be identified in captured image frames and distinguished from other types of pointers such as for example a user's finger. The identity of the pen tool 320 is determined in a manner similar to that described above as the upper portion of the filtered reflector 326 will only reflect IR illumination that has a wavelength in the bandpass range of the filtering element 330.

Although IR-bandpass filters having wavelengths of about 830 nm±12 nm and about 880 nm±12 nm are described above, those skilled in the art will appreciate that other bandpass filters with different peak wavelengths such as 780 nm, 810 nm and 850 may be used. Alternatively, quantum dot filters may be used.

Although the interactive input system 20 is described as comprising two IR LEDs associated with each imaging assembly 60, those skilled in the art will appreciate that more IR LEDs may be used. For example, in another embodiment each imaging assembly 60 comprises three (3) IR LEDs, each having a different peak wavelength and a corresponding IR filter. In this embodiment, three (3) different pen tools are identifiable provided each one of the pen tools has a filtering element associated with one of the IR LEDs and its filter.

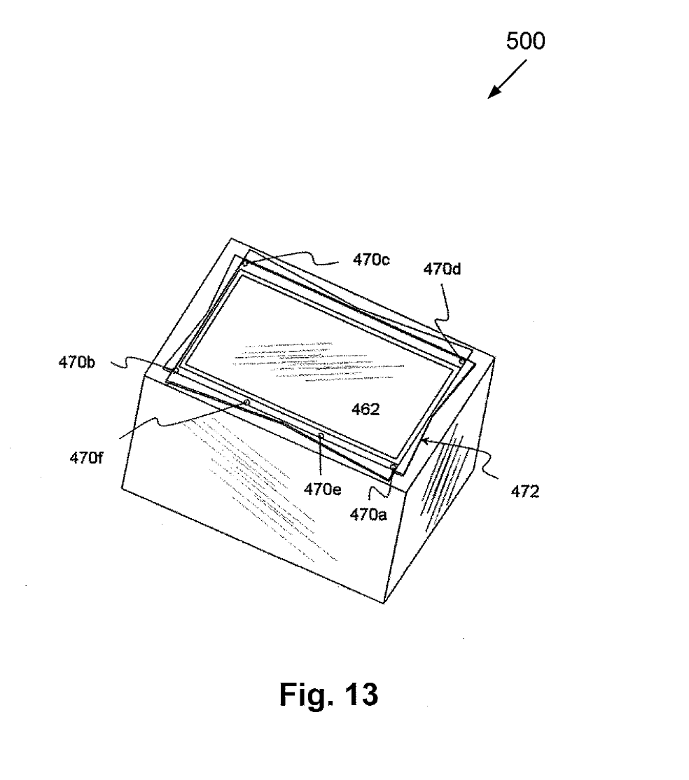

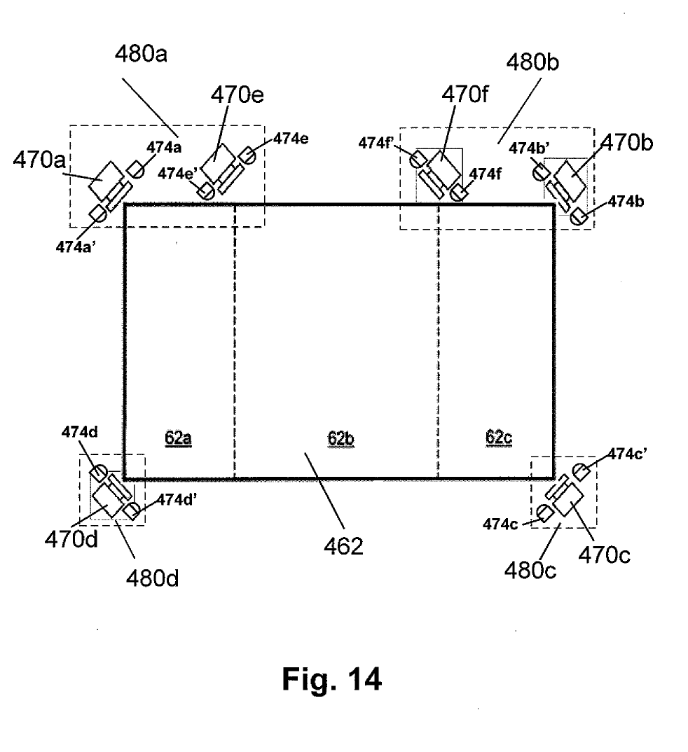

Pen tools 220 and 220′ described above are not only for use with the interactive input system 20 described above, and may alternatively be used with other interactive input systems employing machine vision. For example, FIGS. 13 and 14 show another embodiment of an interactive input system in the form of a touch table, and which is generally referred to using reference numeral 400. Interactive input system 400 is similar to that described in U.S. Patent Application Publication No. 2011/0006981 to Chtchetinine et al., filed on Jul. 10, 2009, and assigned to SMART Technologies, ULC, the relevant portions of the disclosure of which are incorporated herein by reference. Interactive input system 400 comprises six (6) imaging assemblies 470a to 470f positioned about the periphery of an input area 462, and which look generally across the input area 462. An illuminated bezel 472 surrounds the periphery of the input area 462 and generally overlies the imaging assemblies 470a to 470f. The illuminated bezel 472 provides backlight illumination into the input area 462. To detect a pointer, processing structure of interactive input system 400 utilizes a weight matrix method as disclosed in PCT Application No. PCT/CA2010/001085 to Morrison et al., filed on Jan. 13, 2011, and assigned to SMART Technologies, ULC, the relevant portions of the disclosure of which are incorporated herein by reference.

Each imaging assembly 470a to 470f comprises a pair of IR LEDs 474a and 474a′ to 474f and 474f′, respectively, that is configured to flood the input area 462 with infrared illumination. In this embodiment, the imaging assemblies 470a to 470f are grouped into four (4) imaging assembly banks, namely, a first imaging assembly bank 480a comprising imaging assemblies 470a and 470e, a second imaging assembly bank 480b comprising imaging assemblies 470b and 470f, a third imaging assembly bank 480c comprising imaging assembly 470c, and a fourth imaging assembly bank 480d comprising imaging assembly 470d. The imaging assemblies within each bank capture image frames simultaneously. The IR LEDs associated with the imaging assemblies of each bank flood the input area 462 with infrared illumination simultaneously.

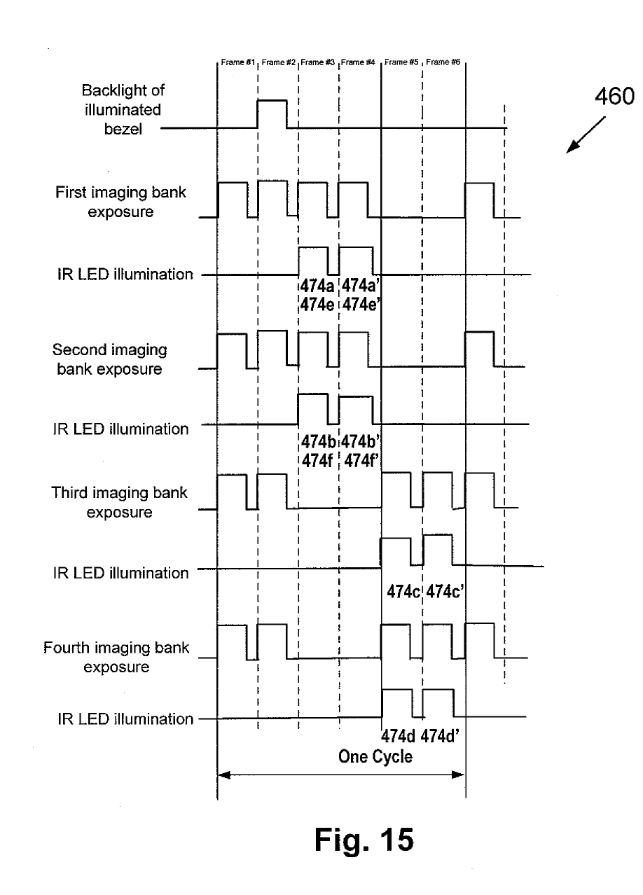

FIG. 15 shows a portion of the image frame capture sequence 460 used by the interactive input system 400. A background image frame (“Frame #1”) is initially captured by each of the imaging assemblies 470a to 470f in each of the imaging assembly banks 480a to 480d with all IR LEDs OFF and with the illuminated bezel 472 OFF. A second image frame (“Frame #2”) is captured by each of the imaging assemblies 470a to 470f in each of the imaging assembly banks 480a to 480d with all IR LEDs OFF and with the illuminated bezel 472 ON. Frame #1 and Frame #2 captured by each imaging assembly bank 480a to 480d are used to determine the location of a pen tool using triangulation. Each of the imaging assembly banks 480a and 480b is then conditioned to capture an image frame (“Frame #3) with IR LEDs 474a, 474e, 474f, 474b ON and IR LEDs 474a′, 474e′, 474f′, 474b′ OFF and then to capture another image frame (“Frame #4) with IR LEDs 474a, 474e, 474f, 474b OFF and IR LEDs 474a′, 474e′, 474f′, 474b′ ON. Imaging assembly banks 480c and 480d and their associated IR LEDs are inactive when Frame #3 and Frame #4 are being captured. Each of the imaging assembly banks 480c and 480d is then conditioned to capture an image frame (“Frame #5) with IR LEDs 474c and 474d ON and IR LEDs 474c′ and 474d′ OFF and then to capture another image frame (“Frame #6) with IR LEDs 474c and 474d OFF and IR LEDs 474c′ and 474d′ ON. Imaging assembly banks 480a and 480b and their associated IR LEDs are inactive when Frame #5 and Frame #6 are being captured. As a result, the exposure of the image sensors of the imaging assemblies 470a to 470f of the four (4) imaging assembly banks 480a to 480d and the powering of the associated IR LEDs 474a to 474f and 474a′ to 474f are staggered to avoid any potential effects resulting from illumination of opposing IR LEDs. To reduce the effects ambient light may have on pointer discrimination, each background image frame (“Frame 1”) is subtracted from the illuminated image frames (“Frame #2” to “Frame #6”) captured by the same imaging assembly 60 as described previously.

Once the sequence of image frames has been captured, the image frames are processed according to an image frame processing method similar to image frame processing method 270 described above to determine the location and identity of any pen tool brought into proximity with the input area 462. In this embodiment, each background image frame (“Frame #1”) is subtracted from the first image frame (“Frame #2”) captured by the same imaging assembly so as to yield a difference image frame (“Difference Image Frame #2”) for each imaging assembly. Each Difference Image Frame #2 is processed to determine the location of a pen tool using triangulation. Each background image frame (“Frame #1”) is subtracted from the remaining image frames (“Frame #3” to “Frame #6) captured by the same imaging assembly. As a result, four difference image frames (“Difference Image Frame #3” to “Difference Image Frame #6”) are generated for each imaging assembly having ambient light removed. The difference image frames (“Difference Image Frame #3” to “Difference Image Frame #6”) are processed to determine one or more pointer analysis regions to determine the identify of any pen tool brought into proximity with the input area 462, similar to that described above.

Although it is described above that each imaging assembly comprises a pair of associated IR LEDs, those skilled in the art will appreciate that the entire interactive input system may utilize only a single pair of IR LEDs in addition to the illuminated bezel. In this embodiment, the image frame capture sequence comprises four (4) image frames. The first image frame of each sequence is captured with the illuminated bezel 472 OFF and with the IR LEDs OFF, so as to obtain a background image frame. The second image frame of each sequence is captured with the illuminated bezel 472 ON and with the IR LEDs OFF, so as to obtain a preliminary illuminated image frame. The first two image frames in the sequence are used to determine the location of a pen tool, using triangulation. The next image frame is captured with the illuminated bezel 472 OFF, a first one of the IR LEDs ON, and a second one of the IR LEDs OFF. The final image frame is captured with the illuminated bezel OFF, the first one of the IR LEDs OFF, and the second one of the IR LEDs ON. The image frames are then processed similar to that described above to detect the location of a pen tool and to identify the pen tool.

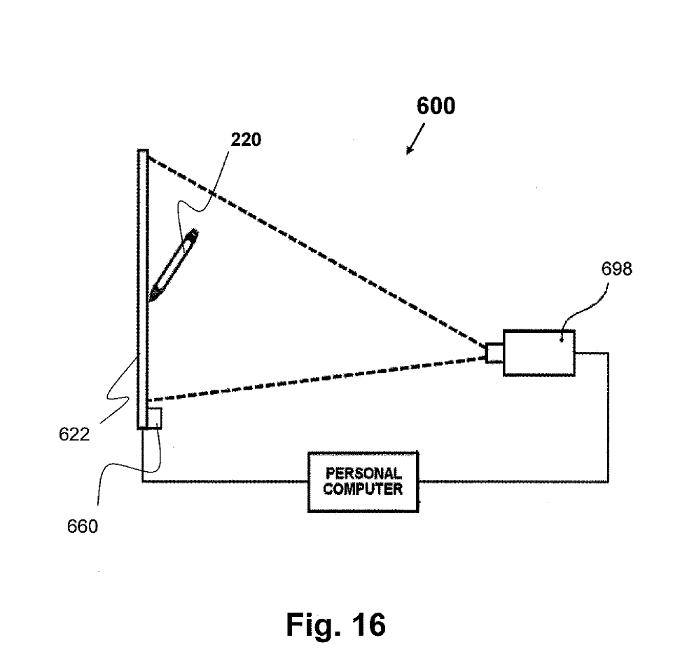

Pen tool 220 and pen tool 220′ may also be used with other interactive input systems. For example, FIG. 16 shows another embodiment of an interactive input system 600 comprising an assembly 622 surrounding a display surface of a front projection system. The front projection system utilizes a projector 698 that projects images on the display surface. Imaging assemblies 660 positioned at the bottom corners of the assembly 622 look across the display surface. Each imaging assembly 660 is generally similar to imaging assembly 60 described above and with reference to FIGS. 1 to 11, and comprises an image sensor (not shown) and a set of IR LEDs (not shown) mounted on a housing assembly (not shown). A DSP unit (not shown) receives image frames captured by the imaging assemblies 660 and carries out the image frame processing method described above.

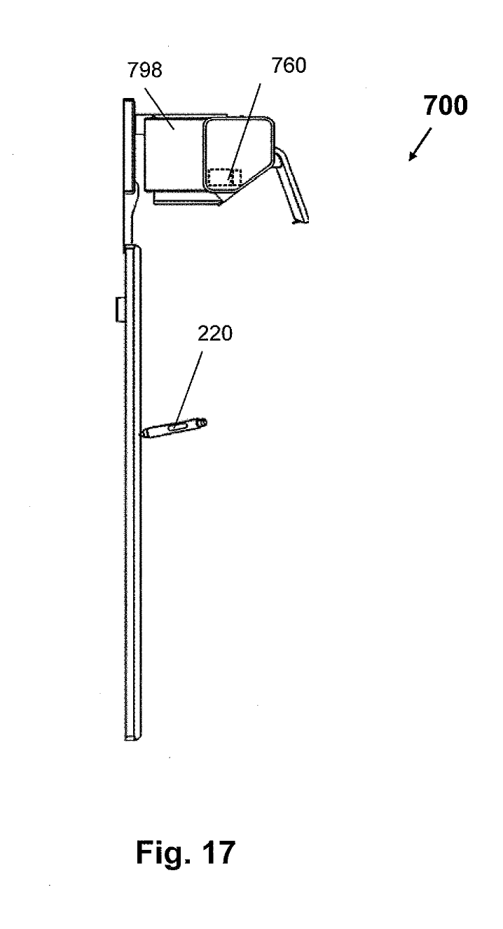

FIG. 17 shows another embodiment of an interactive input system using a front projection system. Interactive input system 700 comprises a single imaging assembly 760 positioned in proximity to a projector 798 and configured for viewing a display surface. Imaging assembly 760 is generally similar to imaging assembly 60 described above and with reference to FIGS. 1 to 11, and comprises an image sensor and a set of IR LEDs mounted on a housing assembly. A DSP unit receives image frames captured by the imaging assembly 760 and carries out the image frame processing method described above.

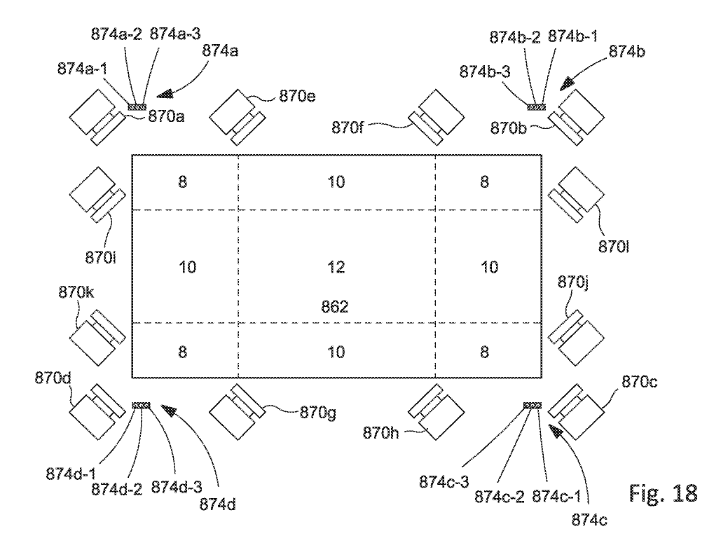

FIG. 18 shows another embodiment of an interactive input system in the form of a touch table, and which is generally referred to using reference numeral 800. Interactive input system 800 is similar to that described in above-mentioned U.S. Patent Application Publication No. 2011/0006981, the relevant portions of the disclosure of which are incorporated herein by reference. Interactive input system 800 comprises twelve (12) imaging assemblies 870a to 870l positioned about the periphery of the input area 862, and which look generally across an input area 862. An illuminated bezel (not shown) surrounds the periphery of the input area 862 and generally overlies the imaging assemblies 870a to 870l. The illuminated bezel provides backlight illumination into the input area 862. Interactive input system 800 operates in pointer detection and pointer identification modes, as will be described below.

In this embodiment, a set of IR LEDs 874a to 874d is positioned adjacent each of the four (4) corner imaging assemblies 870a to 870d. Each set of IR LEDs 874a to 874d comprises three (3) IR LEDS. In particular, the set of IR LEDs 874a comprises IR LEDs 874a-1, 874a-2 and 874a-3, the set of IR LEDs 874b comprises IR LEDs 874b-1, 874b-2 and 874b-3, the set of IR LEDs 874c comprises IR LEDs 874c-1, 874c-2 and 874c-3; and the set of IR LEDs 874c comprises IR LEDs 874d-1, 874d-2 and 874d-3. In this embodiment, IR LEDs 874a-1, 874b-1, 874c-1 and 874c-1 emit infrared illumination at a wavelength of 780 nm, IR LEDs 874a-2, 874b-2, 874c-2 and 874c-2 emit infrared illumination at a wavelength of 850 nm, and IR LEDs 874a-3, 874b-3, 874c-3 and 874c-3 emit infrared illumination at a wavelength of 940 nm. The IR LEDs of each set of IR LEDs 874a to 874d are configured to flood the input area 862 with infrared illumination.

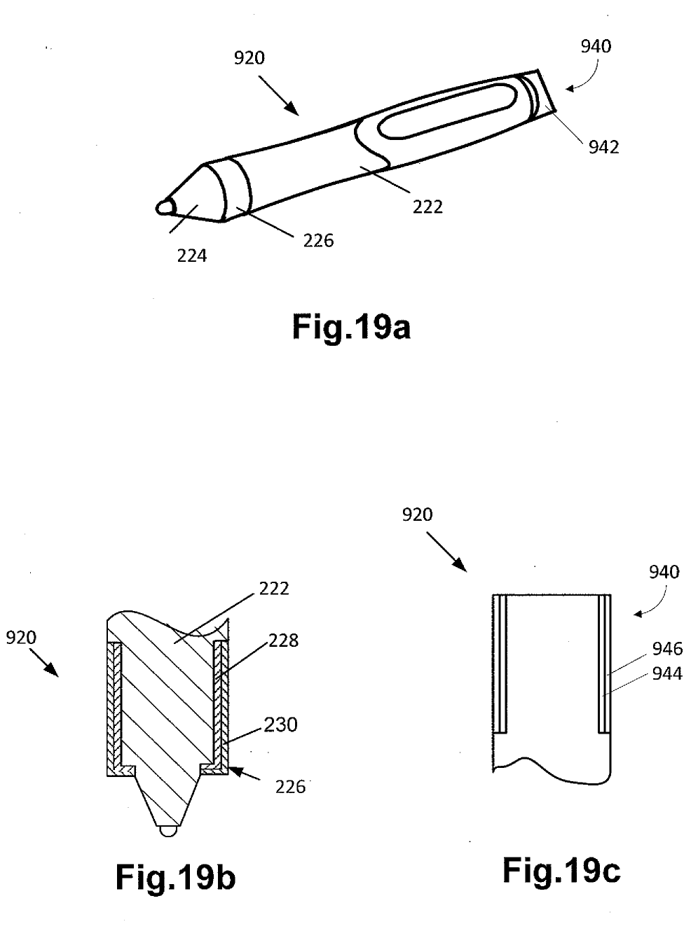

FIGS. 19a to 19c show a first type of pen tool 920 for use with the interactive input system 800. As can be seen, pen tool 920 is similar to pen tool 220 shown in FIGS. 6a and 6b, with the addition of an eraser end 940. In particular, pen tool 920 has a main body 222 terminating in a generally conical tip 224. A filtered reflector 226 is provided on the main body 222 adjacent the tip 224. Filtered reflector 226 comprises a reflective element 228 and a filtering element 230. Reflective element 228 encircles a portion of the main body 222. Filtering element 230 is positioned atop and circumscribes reflective element 228. An eraser end 940 is positioned at the end of the main body 222 opposite that of conical tip 224. A filtered reflector 942 is positioned on the main body 222 at the eraser end 940 and comprises a reflective element 944 and a filtering element 946. The reflective element 944 encircles a portion of the main body 222 and is formed of a retro-reflective material such as for example retro-reflective tape. The filtering element 946 is positioned atop and circumscribes the reflective element 944.

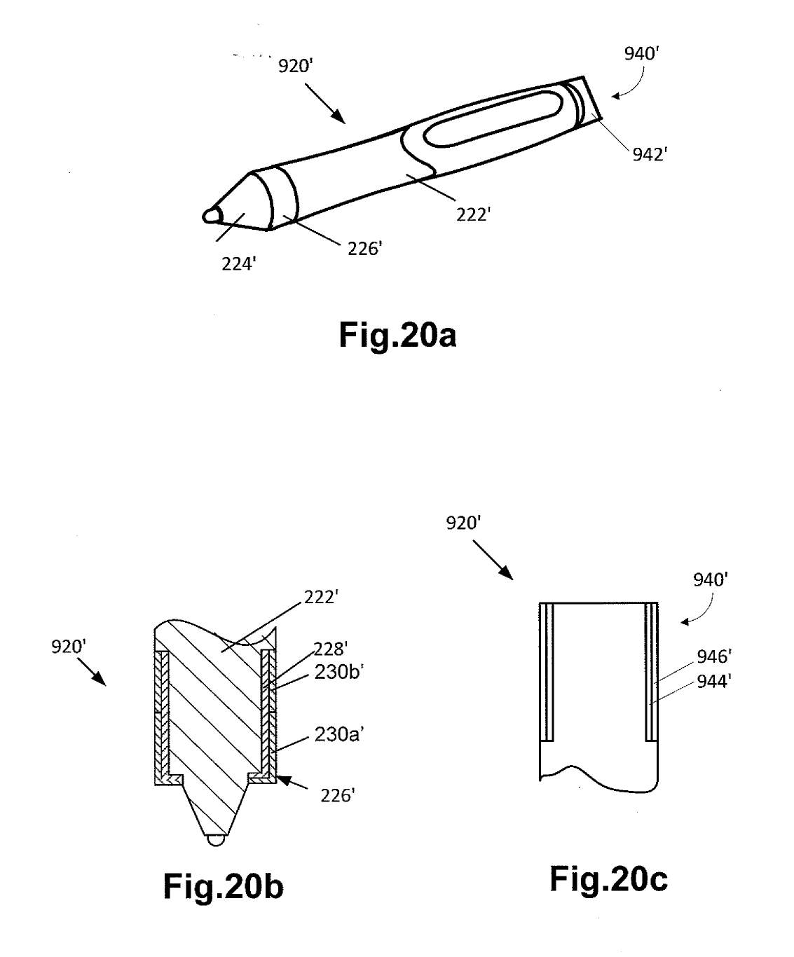

FIGS. 20a to 20c show a second type of pen tool 920′ for use with the interactive input system 800 that is similar to pen tool 920. As can be seen, pen tool 920′ has a main body 222′ terminating in a generally conical tip 224′. A filtered reflector 226′ is provided on the main body 222′ adjacent the tip 224′. Filtered reflector 226′ comprises a reflective element 228′ and filtering elements 230a′ and 230b′. Reflective element 228′ encircles a portion of the main body 222′. Filtering element 230a′ is positioned atop and circumscribes a lower portion of reflective element 228′ and filtering element 230b′ is positioned atop and circumscribes an upper portion of reflective element 228′. The filtering elements 230a′ and 230b′ have different bandpass wavelength ranges. An eraser end 940′ is positioned at the end of the main body 222′ opposite that of conical tip 224′. A filtered reflector 942′ is positioned on the main body 222′ at the eraser end 940′ and comprises a reflective element 944′ and a filtering element 946′. The reflective element 944′ encircles a portion of the main body 222′ and is formed of a retro-reflective material such as retro-reflective tape. The filtering element 946′ is positioned atop and circumscribes the reflective element 944′.

In this embodiment, interactive input system 800 is able to identify four (4) different pen tools, namely two (2) pen tools 920 of the first type (Black and Green) and two (2) pen tools 920′ of the second type (Red and Blue). Each first type of pen tool 920 has a particular filtering element 230 used to identify the pen tool. Each second type of pen tool 920′ has particular filtering elements 230a′ and 230b′ used to identify pen tool. All of the pen tools have a filtering element 944, 944′ positioned adjacent the eraser end 940, 940′ used to detect when the pen tools are being used as an eraser. The four different pen tools 920 and 920′ and the bandpass wavelength ranges of their corresponding filtering elements are shown in Table 1 below:

TABLE 1

| | | | Filtering element(s) |
|---|---|---|---|
| Pen Tool | Pen Tool | Filtering | bandpass wavelength |
| ID | Type | Element | range (±12 nm) |
| Black | pen tool 920 | 230 | 940 nm |
| Red | pen tool 920′ | 230a′ and 230b′ | 940 nm and 850 nm |
| Green | pen tool 920 | 230 | 850 nm |
| Blue | pen tool 920′ | 230a′ and 230b′ | 940 nm and 780 nm |
| Eraser | pen tool 920 | 944 and 944′ | 780 nm |
| | and 920′ | | |

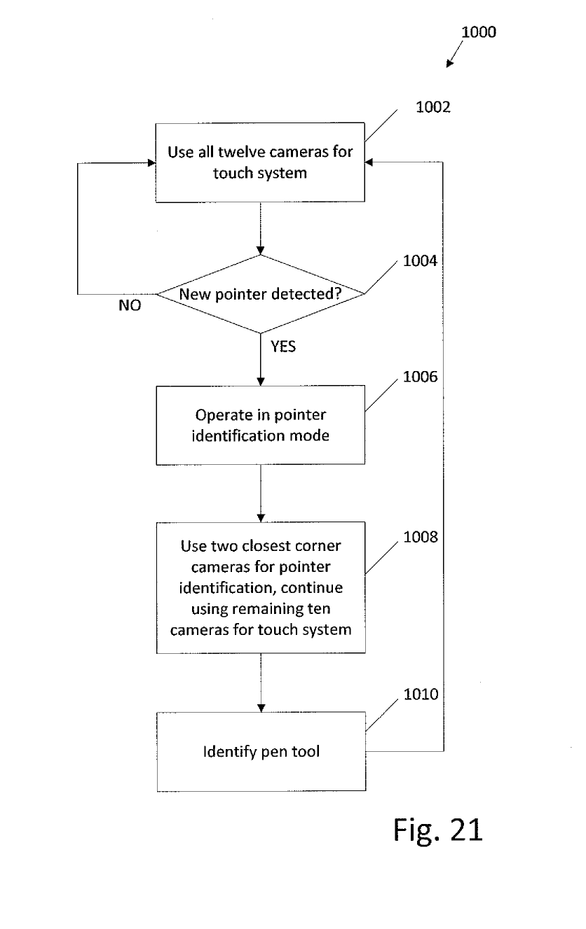

As mentioned previously, the interactive input system 800 operates in pointer detection and pointer identification modes. A flowchart of the method of operation of the interactive input system 800 is shown in FIG. 21 and is generally identified by reference numeral 1000. In the pointer detection mode, the interactive input system 800 uses the twelve imaging assemblies 870a to 870l (step 1002). During operation in the pointer detection mode, processing structure of interactive input system 800 utilizes the weight matrix method disclosed in above-incorporated PCT Application No. PCT/CA2010/001085 to Morrison et al.

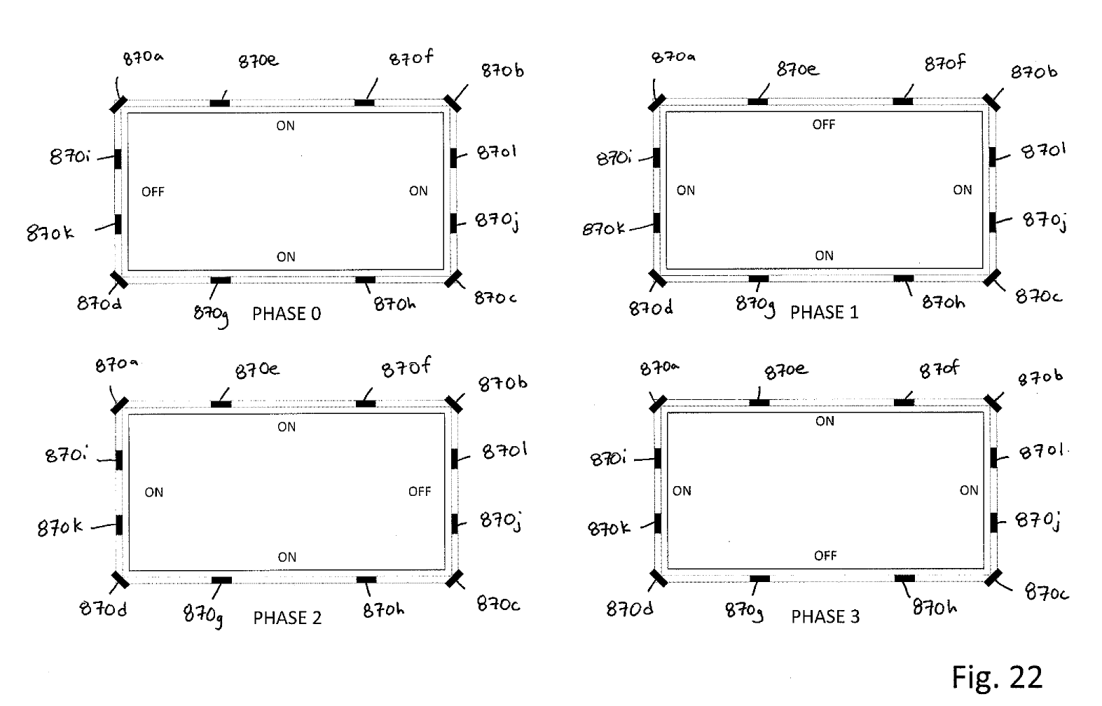

During operation in the pointer detection mode, a pointer detection image frame capture sequence is performed using the twelve imaging assemblies 870a to 870l. Generally, the pointer detection image frame capture sequence comprises eight (8) stages Stage #1 to Stage #8. During the odd numbered stages, that is, Stages #1, #3, #5 and #7, the illuminated bezel and imaging assemblies operate in four phases. The four phases of illuminated bezel illumination are shown in FIG. 22. As can be seen, in phase 0 the west side of the illuminated bezel is OFF, while the remaining sides are ON. In phase 1 the north side of the illuminated bezel is OFF, while the remaining sides are ON. In phase 2 the east side of the illuminated bezel is OFF, while the remaining sides are ON. In phase 3 the south side of the illuminated bezel is OFF, while the remaining sides are ON.

Table 2 below shows the imaging assemblies that are on during each of the four phases. As will be appreciated, in Table 2, “ON” is used to indicate that an imaging assembly is capturing an image frame whereas “OFF” is used to indicate that an imaging assembly is not used to capture an image frame.

TABLE 2

| Imaging | | | | |
|---|---|---|---|---|
| Assembly | Phase 0 | Phase 1 | Phase 2 | Phase 3 |
| 870a | ON | OFF | OFF | OFF |
| 870b | OFF | ON | OFF | OFF |
| 870c | OFF | OFF | ON | OFF |
| 870d | OFF | OFF | OFF | ON |
| 870e | OFF | ON | OFF | OFF |
| 870f | OFF | ON | OFF | OFF |
| 870g | OFF | OFF | OFF | ON |
| 870h | OFF | OFF | OFF | ON |
| 870i | ON | OFF | OFF | OFF |
| 870j | OFF | OFF | ON | OFF |
| 870k | ON | OFF | OFF | OFF |
| 870l | OFF | OFF | ON | OFF |

During the even numbered stages, that is, Stages #2, #4, #6 and #8, the illuminated bezel is off and the imaging assemblies operate in four phases, similar to that shown in Table 2 above.

Once the image frames have been captured, the image frames are processed according to an image frame processing method. The image frames captured during Stages #2, #4, #6 and #8 are summed together and the resultant image frame is used as a background image frame. To reduce the effects of ambient light, difference image frames are calculated by subtracting the background image frame from the image frames captured during Stages #1, #3, #5 and #7. The difference image frames are then examined for values that represent the bezel and possibly one or more pointers. Methods for determining pointer location within image frames are described in U.S. Patent Application Publication No. 2009/0277697 to Bolt et al., filed on May 9, 2008, and assigned to SMART Technologies ULC, the relevant portions of the disclosure of which are incorporated herein by reference. As mentioned above, when a pointer exists in a captured image frame, the pointer occludes illumination and appears as a dark region interrupting a bright band. Thus, the bright bands in the difference image frames are analyzed to determine the locations of dark regions.

A check is performed to determine if a new pointer is detected (step 1004) by determining for example, if the number of detected pointers in the current pointer detection image frame capture sequence has increased as compared to the previous pointer detection image frame capture sequence and/or the location of one or more pointers has changed by more than a threshold amount over the previous and current pointer detection image frame capture sequences. If no new pointer has been detected, the interactive input system 800 continues to operate in the pointer detection mode (step 1002). If a new pointer is detected at step 1004, the interactive input system 800 is conditioned to operate in the pointer identification mode (step 1006). During operation in the pointer identification mode, a pointer identification image frame capture sequence is performed by the two corner imaging assemblies 870a to 870d that are closest to the new pointer to identify the new pointer. The remaining imaging assemblies capture image frames according to the pointer detection image frame capture sequence described above (step 1008).

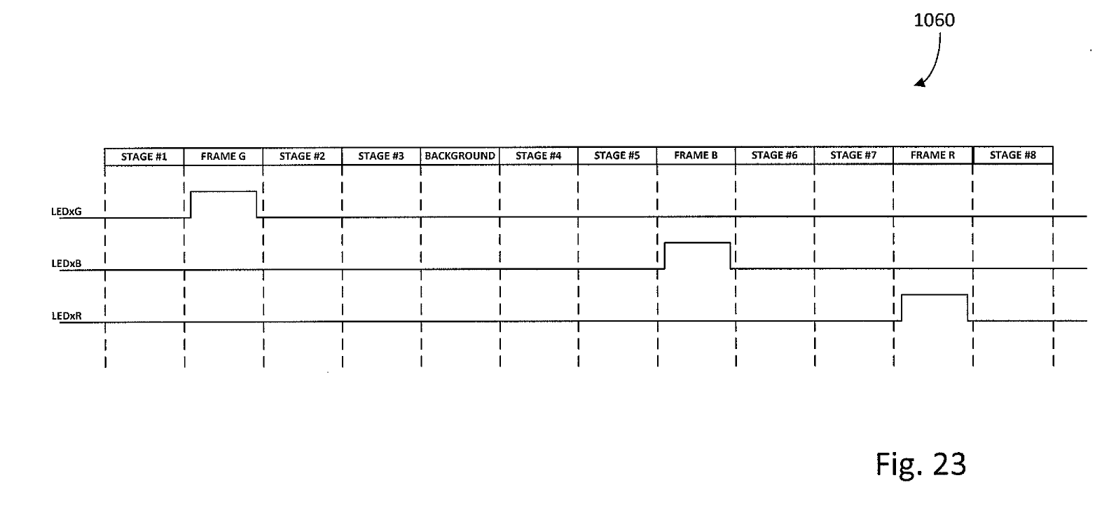

FIG. 23 shows a portion of an exemplary pointer identification image frame capture sequence 1060 used by the two closest corner imaging assemblies during operation of the interactive input system 800 in the pointer identification mode. In this example, the two corner imaging assemblies used to identify the new pointer are imaging assemblies 870a and 870b. The corner imaging assemblies 870a and 870b remain idle until Stage #1 of the pointer detection image frame capture sequence is complete. Once Stage #1 is complete, an image frame is captured by the imaging assemblies 870a and 870b with IR LEDs 874a-1 and 874b-1 ON (“Image Frame G”) and with the illuminated bezel OFF. The corner imaging assemblies 870a and 870b then remain idle until Stages #2 and #3 of the pointer detection image frame capture sequence are complete. Once Stages #2 and #3 are complete, an image frame is captured by the imaging assemblies 870a and 870b with all IR LEDs OFF (“Background Image Frame”). The corner imaging assemblies 870a and 870b then remain idle until Stages #4 and #5 of the pointer detection image frame capture sequence are complete. Once Stages #4 and #5 are complete, an image frame is captured by the imaging assemblies 870a and 870b with IR LEDs 874a-2 and 874b-2 ON (“Image Frame B”) and with the illuminated bezel OFF. The corner imaging assemblies 870a and 870b then remain idle until Stages #6 and #7 of the pointer detection image frame capture sequence are complete. Once Stages #6 and #7 are complete, an image frame is captured by the imaging assemblies 870a and 870b with IR LEDs 874a-3 and 874b-3 ON (“Image Frame R”) and with the illuminated bezel OFF. Stage #8 of the pointer detection image frame capture sequence is then performed.

Once the sequence of image frames has been captured, the Background Image Frame is subtracted from Image Frame G, Image Frame B and Image Frame R resulting in Difference Image Frame G, Difference Image Frame B and Difference Image Frame R, respectively. The three Difference Image Frames R, G and B are processed to determine the identity of any pen tool brought into proximity with the input area 862 (step 1010).

In this embodiment, the three Difference Image Frames R, G and B are processed to define one or more pointer analysis regions and to calculate an intensity signal corresponding to the presence of the new pointer. The intensity signals are calculated according to Equations (1) to (3) below:

Rₚₑₙ=Σ_{x=X}0_{-WX}1^{+W}R(x) (1)

Gₚₑₙ=Σ_{x=X}0_{-WX}1^{+W}G(X) (2)

Bₚₑₙ=Σ_{x=X}0_{-WX}1^{+W}B(x) (3)

wherein the pointer analysis region is defined between columns X₀<x<X₁, and W is a predefined widening factor.

The maximum value of the intensity signals Rₚₑₙ, Gₚₑₙ and Bₚₑₙ is determined and compared to an intensity threshold. If the maximum value is below the intensity threshold, it is determined that the new pointer is not a pen tool and the interactive input system 800 reverts back to operation in the pointer detection mode using all twelve imaging assemblies. If the maximum value is above the intensity threshold, it is determined that the new pointer is a pen tool and the intensity signals are normalized according to Equations (4) to (7) below so that the maximum value of the intensity signals is set to unity:

m=max(Rₚₑₙ,Gₚₑₙ,Bₚₑₙ) (4)

Rₙ=Rₚₑₙ/m (5)

Gₙ=Gₚₑₙ/m (6)

Bₙ=Bₚₑₙ/m (7)

The normalized intensity signals Rₙ, Gₙ and Bₙ are compared to respective threshold values Rₜ, Gₜ and Bₜ to identify the pen tool. Table 3 shows the criteria for identifying the pen tools of Table 1:

TABLE 3

| Pen Tool ID | Rₙ > Rₜ? | Gₙ > Gₜ | Bₙ > Bₜ |
|---|---|---|---|
| Black | YES | NO | NO |
| Red | YES | YES | NO |
| Green | NO | YES | NO |
| Blue | YES | NO | YES |
| Eraser | NO | NO | YES |

Once the new pen tool is identified (in step 1010), the method returns to step 1002 wherein the interactive input system 800 operates in the pointer detection mode.

In another embodiment, a tool tray similar to that described above may be used with interactive input system 800. In this embodiment, the tool tray is used to support one or more of the pen tools 920 and 920′. When operating in the pointer identification mode, image frames captured by imaging assemblies 870a and 870b include images of the tool tray and any pen tools supported thereon. As such, the interactive input system 800 is able to determine when a pen tool is removed from the tool tray, is able to identify the removed pen tool, and can assume that the next detected pen tool brought into proximity with the input area 862 is the removed pen tool.

Although interactive input system 800 is described as comprising four sets of three infrared LEDs positioned adjacent to respective imaging assemblies 870a to 870d, those skilled in the art will appreciate that variations are available. For example, in another embodiment four sets of two infrared LEDs may be positioned adjacent the respective imaging assemblies 870a to 870d. It will be appreciated that in this embodiment two different pen tools 920 and 920′ of the first and second types may be identified. To identify additional pen tools, more infrared LEDs may be used. For example, in another embodiment, four sets of four infrared LEDs may be positioned adjacent to respective imaging assemblies 870a to 870d.

Although during operation in the pointer identification mode the interactive input system 800 is described as using the two corner imaging assemblies closest to the new pointer, those skilled in the art will appreciate that alternative are available. For example, in another embodiment the interactive input system 800 may use all four corner imaging assemblies for new pointer identification. In another embodiment, in the event the new pointer is within a threshold distance from one of the corner imaging assemblies, that imaging assembly is not used for pointer identification and thus the next closest corner imaging assembly is used in its place. In another embodiment, in the event that the new pointer and another pointer are in proximity within the input area 862 and the new pointer is occluded and cannot be seen by one of the corner imaging assemblies, that imaging assembly is not used for pointer identification but rather the next closest corner imaging assembly is used in its place.

Pen tools 920 and 920′ are not only for use with interactive input system 800 described above. For example, in another embodiment, an interactive input system similar to interactive input system 20 may be used. In this embodiment, rather than the infrared LEDs being positioned on the housing of the imaging assemblies, as is the case with interactive input system 20, the infrared LEDs are positioned adjacent to the imaging assemblies, similar to that of interactive input system 800. In this embodiment, three infrared LEDs are positioned adjacent each imaging assembly. Each one of the three infrared LEDs emits infrared illumination at a particular wavelength, which in this embodiment is 780 nm, 850 nm and 940 nm. As will be appreciated, in this embodiment, the interactive input system is able to track multiple pen tools brought into proximity with the input area but is not able to assign a unique ID to each pen tool.

The two different pen tools 920 and 920′ and their corresponding filtering element(s) used in this embodiment are shown in Table 4:

TABLE 4

| | | | Filtering element(s) |
|---|---|---|---|
| Pen Tool | Pen Tool | Filtering | bandpass wavelength |
| ID | Type | Element | range (±12 nm) |
| Black | pen tool 920 | 230 | 940 nm |
| Red | pen tool 920′ | 230a′ and 230b′ | 940 nm and 850 nm |
| Eraser | pen tool 920 | 944 and 944′ | 780 nm |
| | and 920′ | | |

An image frame capture sequence is performed by the imaging assemblies of the interactive input system, similar to image frame capture sequence 1060 described above. Generally, three image frames R, G and B are captured by each imaging assembly. Each image frame R, G and B corresponds to an image frame captured when a respective IR LED is ON. Difference image frames R, G and B are calculated as described above. Intensity signals R(x), G(x) and B(x) are calculated and compared to the intensity signals R_{b}(x), G_{b}(x) and B_{b}(x) of the corresponding background image frame to determine if a pointer has been brought into proximity with the interactive surface. In this embodiment, if the intensity signal R(x), G(x) and B(x) is less than 75% of the respective intensity signal R_{b}(x), G_{b}(x) and B_{b}(x) of the corresponding background image frame, it is determined that a pointer has been brought into proximity with the interactive surface. For example, if the intensity signal R(x)<0.75R_{b}(x), it is determined than a pointer has been brought into proximity with the interactive surface. For calculation, it is assumed that the pointer is not a pen tool.

To test if the pointer is a pen tool, the intensity signal R(x) is used for calculating predicted intensity signals Gₚ(x) and Bₚ(x) for the intensity signals G(x) and B(x). This is because both pen tools in Table 3 would appear in the image frame R captured when the IR LED emitting a wavelength of 940 nm is ON. The predicted intensity signals Gₚ(x) and Bₚ(x) are calculated according to Equations (8) and (9) below:

$$\begin{matrix}{G}_{p} ( x ) = {G}_{b} ( x ) \frac{R ( x )}{{R}_{b} ( x )} & ( 8 ) \\ {B}_{p} ( x ) = {B}_{b} ( x ) \frac{R ( x )}{{R}_{b} ( x )} & ( 9 )\end{matrix}$$

The predicted intensity signals Gₚ(x) and Bₚ(x) are subtracted from the intensity signals G(x) and B(x) to calculate residual intensity signals and the residual intensity signals are summed according to Equations (10) to (12) below:

Rₚₑₙ=0 (10)

Gₚₑₙ=Σ_{x=X}_{₀}_{-WX}^{₁}^{+W}[G(x)−Gₚ(x)] (11)

Bₚₑₙ=Σ_{x=X}_{₀}_{-WX}^{₁}^{+W}[B(x)−Bₚ(x) (12)

wherein the pointer analysis region is defined between columns X₀<x<X₁, and W is a predefined widening factor.

The residual intensity signals Rₚₑₙ, Gₚₑₙ and Bₚₑₙ represent the signal coming from the reflective element of the pen tool with the signal from the retro-reflective bezel removed.

The above calculations are repeated to test if the pointer is the eraser end of the pen tool. As will be appreciated, in this case, the intensity signal B(x) is used for calculating predicted intensity signals Gₚ(x) and Rₚ(x) for the intensity signals G(x) and R(x). This is because the eraser in Table 3 would appear in image frame B captured when the IR LED emitting a wavelength of 780 nm is ON. The intensity signals Rₚₑₙ and Gₚₑₙ are calculated similar to that described above, wherein the intensity signal Bₚₑₙ is set to zero.

The residual intensity signals Rₚₑₙ, Gₚₑₙ and Bₚₑₙ calculated are interpreted to determine if the pointer is a pen tool or the eraser end of the pen tool similar to that described above with reference to Equations (4) to (7) and Table 3. Table 5 below shows the criteria for identifying each pen tool of Table 4:

TABLE 5

| Pen Tool ID | Rₙ > Rₜ? | Gₙ > Gₜ | Bₙ > Bₜ |
|---|---|---|---|
| Black | YES | NO | NO |
| Red | YES | YES | NO |
| Eraser | NO | NO | YES |

In another embodiment, image frames captured by imaging assemblies of interactive input system 110 may include images of the tool tray and any pen tools supported thereon. As such, the interactive input system is able to determine when a pen tool is removed from the tool tray, is able to identify the removed pen tool, and can assume that the next detected pen tool brought into proximity with the interactive surface is the removed pen tool.

Although in embodiments described above difference image frames are obtained by subtracting background image frames from illuminated image frames, where the background image frames and the illuminated image frames are captured successively, in other embodiments, the difference image frames may be obtained using an alternative approach. For example, the difference image frames may be obtained by dividing the background image frames by the illuminated image frames, or vice versa. In still other embodiments, non-successive image frames may be used for obtaining the difference image frames.

Although in embodiments described above the pointer analysis region is described as being square shaped, those skilled in the art will appreciate that the pointer analysis region may be another shape such as for example rectangular, circular, etc. Also, although in the embodiments described above, the light sources emit infrared illumination, in other embodiments, illumination of other wavelengths may alternatively be emitted.

Although in embodiments described above, IR-bandpass filters having wavelengths of about 830 nm±12 nm and about 880 nm±12 nm are employed, those skilled in the art will appreciate that high pass filters may be used. For example, in another embodiment a high pass filter having a passband above about 750 nm may be associated with each located pointer.

Although in embodiments described above a single pointer analysis region is associated with each located pointer, in other embodiments, multiple pointer analysis regions may be associated with each located pointer.

Although preferred embodiments have been described, those of skill in the art will appreciate that variations and modifications may be made with departing from the scope thereof as defined by the appended claims.

What is claimed is:

1. A pen tool comprising:
an elongate body;
a tip adjacent one end the body; and
a filtered reflector disposed on the body, the filtered reflector comprising a reflecting portion and at least one filtering element, the at least one filtering element configured to permit illumination emitted at a selected wavelength to pass therethrough and impinge on the reflecting portion and to permit illumination at the selected wavelength that is reflected by the reflecting portion to exit the filtered reflector.

2. The pen tool of claim 1, wherein the at least one filtering element is an optical bandpass filter having a peak wavelength corresponding to the selected wavelength.

3. The pen tool of claim 1 wherein the selected wavelength is associated with a pen tool attribute.

4. The pen tool of claim 3 wherein the pen tool attribute is one of a pen color and a pen function.

5. The pen tool of claim 1 wherein the selected wavelength provides an identification of a particular user.

6. The pen tool of claim 1 wherein the filtered reflector comprises two filtering elements, one of the filtering elements configured to permit illumination emitted at a first selected wavelength to pass therethrough and impinge on the reflecting portion and to permit illumination at the selected wavelength that is reflected by the reflecting portion to exit the filtered reflector, the other of the filtering elements configured to permit illumination emitted at a second selected wavelength to pass therethrough and impinge on the reflecting portion and to permit illumination at the selected wavelength that is reflected by the reflecting portion to exit the filtered reflector, the first selected wavelength being different than the second selected wavelength.

7. An interactive input system comprising:
at least one imaging assembly having a field of view aimed into a region of interest and capturing image frames thereof;
at least one light source configured to emit illumination into the region of interest at a selected wavelength; and
processing structure configured to process the captured image frames to determine a location of at least one pointer in a first region of the captured image frames, to define a pointer analysis region in the captured image frames separate from the first region, and to identify the at least one pointer based on a calculated intensity of at least a portion of the pointer analysis region.

8. The interactive input system of claim 7 wherein the at least one pointer appears in the first region as a dark region against a bright band.

9. The interactive input system of claim 7, wherein the at least one light source is positioned adjacent to the at least one imaging assembly.

10. The interactive input system of claim 7, wherein the at least one pointer comprises a filtered reflector having a reflecting portion and at least one filtering element, the at least one filtering element configured to permit illumination emitted at the selected wavelength to pass therethrough and impinge on the reflecting portion and to permit illumination at the selected wavelength that is reflected by the reflecting portion to exit the filtered reflector.

11. The interactive input system of claim 7 wherein the processing structure is configured to compare the intensity of the at least a portion of pointer analysis region to an intensity threshold and to identify the at least one pointer if the intensity is above the intensity threshold.

12. The interactive input system of claim 7, wherein the identity of the pointer is associated with a pointer attribute.

13. The interactive input system of claim 7 wherein the identity of the pointer is associated with a particular user.

14. The interactive input system of claim 7 comprising at least two light sources positioned adjacent to the at least one imaging assembly configured to selectively emit illumination into the region of interest at respective first and second selected wavelengths.

15. The interactive input system of claim 14 wherein the processing structure is configured to determine if the pointer is associated with one of the first and second selected wavelengths based on the intensity of the at least a portion of the pointer analysis region.

16. The interactive input system of claim 15 wherein the at least one imaging assembly captures a sequence of image frames, the sequence comprising one image frame captured when both of the at least two light sources are in an off state, a first image frame when a first one of the at least two light sources is in an on state and a second one of the at least two light sources is in the off state, and a second image frame captured when the second one of the at least two light sources is in the on state and the first one of the at least two light sources is in the off state.

17. The interactive input system of claim 16, wherein the processing structure is configured to subtract the image frame captured when the at least two light sources are in the off state from the first and second image frames to form first and second difference image frames, and to define the pointer analysis region in at least one of the first and second difference image frames.

18. The interactive input system of claim 17, wherein the processing structure is configured to identify the at least one pointer if the intensity of the at least a portion of the pointer analysis region is above an intensity threshold in the at least one of the first and second difference image frames.

19. The interactive input system of claim 18 wherein the pointer has a first pointer identity if the intensity is above the intensity threshold in the first difference image frame and a second pointer identity if the intensity is above the intensity threshold in the second difference image frame.

20. The interactive input system of claim 19 wherein the pointer has a third pointer identity if the intensity is above the intensity threshold in both the first and second difference image frames.

21. A method of identifying at least one pointer brought into proximity with an interactive input system, the method comprising:
emitting illumination into a region of interest from at least one light source at a selected wavelength;
capturing image frames of the region of interest; and
processing the captured image frames to determine a location of at least one pointer in a first region of the captured image frames, to define a pointer analysis region in the captured image frames separate from the first region, and to identify the at least one pointer based on a calculated intensity of at least a portion of the pointer analysis region.

22. The method of claim 21, wherein the at least one pointer appears in the first region as a dark region against a bright band.

23. The method of claim 21 comprising comparing the intensity to an intensity threshold, and determining the identity of the at least one pointer if the intensity is above the intensity threshold.

24. The method of claim 21, further comprising:
selectively emitting illumination into the region of interest from at least two light sources, the at least two light sources emitting illumination at respective first and second selected wavelengths.

25. The method of claim 24, wherein the processing comprises determining if the pointer is associated with one of the first and second selected wavelengths based on the intensity of the pointer analysis region.

26. The method of claim 25 comprising capturing a sequence of image frames, the sequence comprising one image frame captured when both of the at least two light sources are in an off state, a first image frame when a first one of the at least two light sources is in an on state and a second one of the at least two light sources is in the off state, and a second image frame captured when the second one of the at least two light sources is in the on state and the first one of the at least two light sources is in the off state.

27. The method of claim 26, wherein the processing comprises subtracting the image frame captured when the at least two light sources are in the off state from the first and second image frames to form a first and second difference image frame, and defining the pointer analysis region in at least one of the first and second difference image frames.

28. The method of claim 27, wherein the processing comprises identifying the at least one pointer if the intensity of the pointer analysis region is above an intensity threshold in the at least one of the first and second difference image frames.

29. The method of claim 28, wherein the pointer has a first pointer identity if the intensity is above the intensity threshold in the first difference image frame and a second pointer identity if the intensity is above the intensity threshold in the second difference image frame.

30. The method of claim 29 wherein the pointer has a third pointer identity if the intensity is above the intensity threshold in both the first and second different image frames.

31. A non-transitory computer readable medium tangibly embodying a computer program for execution by a computer to perform a method for identifying at least one pointer brought into proximity with an interactive input system, the method comprising:
emitting illumination into a region of interest from at least one light source at a selected wavelength;
capturing image frames of the region of interest; and
processing the captured image frames to determine a location of at least one pointer in a first region of the captured image frames, to define a pointer analysis region in the captured image frames separate from the first region, and to identify the at least one pointer based on a calculated intensity of at least a portion of the pointer analysis region.
